(19) United States
(12) Patent Application Publication
(10) Pub. No.: US 2024/0086709 A1
(43) Pub. Date: Mar. 14, 2024

(54) DEEP LEARNING COMPUTE PATHS FOR FASTER VEHICLE REACTION TIMES

(71) Applicant: GM Cruise Holdings LLC, San Francisco, CA (US)

(72) Inventor: Burkay Donderici, Burlingame, CA (US)

(21) Appl. No.: 17/942,857

(22) Filed: Sep. 12, 2022

(51) Int. Cl. G06N 3/08; G06N 3/04

(52) U.S. Cl. CPC G06N 3/082; G06N 3/0481

(57) ABSTRACT

Systems and techniques are provided for learning deep learning compute paths. An example method can determine a neural network element of a first compute path within a neural network, the first compute path comprising neural network elements including the neural network element, the neural network element comprising a neural network layer and/or a neural network node; determine a second compute path comprising the neural network element and different neural network elements, the second compute path having a smaller size than the first compute path, a lower latency than the first compute path, and/or a smaller compute cost than the second compute path; determine, based on one or more conditions, whether to process data from the neural network element through the first compute path or the second compute path; and process the data from the neural network element through one of the first compute path or the second compute path.

### TECHNICAL FIELD

The present disclosure generally relates to machine learning. For example, aspects of the present disclosure relate to systems and techniques for deep learning compute paths of an autonomous vehicle for faster reaction times by the autonomous vehicle.

### BACKGROUND

An autonomous vehicle is a motorized vehicle that can navigate without a human driver. An exemplary autonomous vehicle can include various sensors, such as a camera sensor, a light detection and ranging (LIDAR) sensor, and a radio detection and ranging (RADAR) sensor, amongst others. The sensors collect data and measurements that the autonomous vehicle can use for operations such as navigation. The sensors can provide the data and measurements to an internal computing system of the autonomous vehicle, which can use the data and measurements to control a mechanical system of the autonomous vehicle, such as a vehicle propulsion system, a braking system, or a steering system. Typically, the sensors are mounted at specific locations on the autonomous vehicles.

### BRIEF DESCRIPTION OF THE DRAWINGS

Illustrative examples and aspects of the present application are described in detail below with reference to the following figures:

FIG. 1 is a diagram illustrating an example system environment that can be used to facilitate autonomous vehicle (AV) navigation and routing operations, in accordance with some examples of the present disclosure;

FIG. 2 illustrates an example configuration of a neural network implemented by an autonomous vehicle, in accordance with some examples of the present disclosure;

FIG. 3 illustrates an example use of a neural network to perform deep learning and classification, in accordance with some examples of the present disclosure;

FIG. 4 is a diagram illustrating example compute paths of a neural network learned, in accordance with some examples of the present disclosure;

FIG. 5 is a diagram illustrating example neural network models used to implement different compute paths, in accordance with some examples of the present disclosure;

FIG. 6 is a diagram illustrating an example compute path with an early exit branch, in accordance with some examples of the present disclosure;

FIG. 7 is a flowchart illustrating an example process for learning and implementing deep learning compute paths, in accordance with some examples of the present disclosure;

FIG. 8 is a diagram illustrating an example system architecture for implementing certain aspects described herein.

### DETAILED DESCRIPTION

Certain aspects and examples of this disclosure are provided below. Some of these aspects and examples may be applied independently and some of them may be applied in combination as would be apparent to those of skill in the art. In the following description, for the purposes of explanation, specific details are set forth in order to provide a thorough understanding of aspects and examples of the application. However, it will be apparent that various aspects and examples may be practiced without these specific details. The figures and description are not intended to be restrictive.

The ensuing description provides various details and non-limiting examples, and is not intended to limit the scope, applicability, or configuration of the disclosure. Rather, the ensuing description of the examples and aspects of the disclosure will provide those skilled in the art with an enabling description for implementing an example of the systems and techniques described herein. It should be understood that various changes may be made in the function and arrangement of elements without departing from the scope of the application as set forth in the appended claims.

One aspect of the present technology is the gathering and use of data available from various sources to improve quality and experience. The present disclosure contemplates that in some instances, this gathered data may include personal information. The present disclosure contemplates that the entities involved with such personal information respect and value privacy policies and practices.

As previously explained, autonomous vehicles (AVs) can include various sensors, such as a camera sensor(s), a light detection and ranging (LIDAR) sensor(s), a radio detection and ranging (RADAR) sensor(s), an inertial measurement unit(s) (IMU), amongst others, which the AVs can use to collect data and measurements that the AVs can use for operations such as navigation. The sensors can provide the data and measurements to an internal computing system of the autonomous vehicle, which can use the data and measurements to control a mechanical system of the autonomous vehicle, such as a vehicle propulsion system, a braking system, or a steering system.

AV software is generally constructed using frameworks such as, for example, a robot operating system (ROS). An ROS can include software stacks that communicate with other software stacks. In some examples, a software stack can include and/or represent a process, a service, a software algorithm, and/or software code of the ROS of an AV. Software stacks can take actions based on information received from other software stacks, send information to other software stacks, or send and receive requests for actions to and from other software stacks. In many cases, the AV can implement one or more deep learning models to perform one or more operations (e.g., tasks, actions, functions, behaviors, maneuvers, etc.). For example, the functionality of one or more software stacks can be achieved using one or more deep learning models and/or the data processed (e.g., data inputs, data outputs, etc.) by one or more software stacks can be generated by one or more deep learning models.

Generally, to perform an operation, an AV can implement a particular deep learning model and/or can execute and/or traverse a particular compute path associated with that operation. The particular compute path associated with the operation can include, for example and without limitation, a specific set of nodes and/or layers of a deep learning model. The specific set of nodes and/or layers of the deep learning model can process input data in order to perform the operation. In some examples, a compute path associated with an AV operation can include a particular deep learning model and/or a particular set of nodes and layers of a deep learning model implemented by an AV computer system to perform the AV operation. To illustrate, a compute path associated with an AV operation can include a path through/within a neural network configured to and/or used to perform the AV operation, or a particular neural network model used to perform the AV operation.

In some cases, the compute path through/within a neural network can include, for example and without limitation, a particular set and/or sequence of neural network layers, neurons, activation functions, transfer functions, filters, neural network branches, connections, loops, parameters, and/or any other neural network components. In some examples, the compute path through/within a neural network can also include one or more specific processing and/or data flows or directions (e.g., a direction or flow of data, a direction or sequence of path elements, a direction or flow of inputs and outputs, a flow of functions/operations, etc.) such as, for example and without limitation, a feedforward path where data flows in one direction (e.g., forward, from input nodes through intermediate nodes to output nodes, etc.), a feedback (or recurrent) path where at least some of the data processed flows in a backward direction and/or data can flow in both forward and backward directions, etc.

As used herein, an operation performed or executed by an AV (and/or a component(s) of an AV) can refer to one or more actions, behaviors, functions, maneuvers, tasks, and/or processes performed or executed by the AV. Non-limiting examples of operations performed or executed by an AV can include navigation, planning, prediction, localization, tracking, mapping, autonomous driving, driver assistance, autonomous actions, communications, perception (e.g., detection, classification, etc.), monitoring, sensor data processing, object/event detection and/or recognition, and control actions (e.g., controlling the AV and/or certain components of the AV such as mechanical systems, electrical systems, etc.), among others.

In some examples, an AV can have a static compute path that the AV uses to perform a particular operation. The static compute path can include, for example, a particular neural network model or a particular path within a neural network model. In other examples, the AV can have multiple compute paths available to perform a particular operation. For example, the AV may have several different sets of nodes, layers, activation functions, etc., of a neural network that can be used and/or invoked by the AV to execute a particular operation. In other words, in some cases the AV may only have one static compute path available to perform or execute a particular operation and, in other cases, the AV may have multiple, static compute paths available to perform or execute the particular operation (e.g., each of the compute paths can accomplish the particular operation). The AV can heuristically select a particular compute path from multiple, static compute paths to perform an associated operation. However, the AV is generally unable to learn compute paths and/or dynamically select a learned compute path.

Generally, each node and/or layer in a particular compute path can generate an output and/or perform an action used by/for an operation (e.g., the action can produce the operation, can be one of a number of actions used to perform the operation, and/or can be a dependency for one or more actions or operations used to perform the operation) and/or used by another node and/or layer along the compute path associated with the operation. For example, each layer of a neural network along a compute path within the neural network can generate an output that is used as an input to (e.g., and/or is a data dependency of) another layer in the compute path until the operation is performed/completed by the layers in the compute path associated with that operation and/or until a final command/instruction for initiating and/or executing the operation is generated by one or more of the nodes within the compute path.

In many cases, a deep learning model implemented by an AV may include a significant number of nodes and/or layers. Thus, a compute path used by an AV to perform an operation may involve/include a large number of nodes and/or layers. In some cases, an increasing number of nodes and/or layers involved or included in a compute path can result in a higher compute cost/footprint, a higher burden on compute resources, and/or a higher delay/latency when performing a particular operation using the compute path. For example, a compute path used to perform an operation can impose a high cost or burden on compute resources used by the AV to execute the compute path and perform the operation. Moreover, the AV may implement a large neural network model that can have a high compute cost/footprint. In some cases, even if the AV implements a particular compute path within a neural network model, the neural network model can include nodes and layers that are not part of the compute path (and thus may not be invoked/used) but may nevertheless utilize compute resources. The compute used by a particular compute path or neural network model can reduced the amount of compute resources available to the AV for other operations.

As another example, a compute path used to perform an operation can include a certain delay/latency between the time the operation is triggered and the time that the operation is performed/completed (e.g., the time that the compute path associated with the operation is traversed and/or executed). The delay/latency associated with an operation can increase based on one or more factors such as, for example, a number of neural network nodes and/or layers in a compute path used to perform the operation, a complexity of functions/actions performed by one or more nodes and/or layers in the compute path used to perform the operation, an amount of data processed by nodes in the compute path in order to perform the operation, and/or other factors.

In some examples, the delay/latency associated with an operation can increase the difficulty of performing the operation safely within a particular period of time or time window available to perform the operation, or may even prevent the autonomous vehicle from performing such operation if the delay/latency associated with the operation exceeds a threshold and/or if the operation, when performed according to the delay/latency, results in an estimated safety or performance metric below a particular threshold. Moreover, given the fast pace in which an AV often has to understand a scene and/or perform an operation in the scene (e.g., respond or react to an object/event/stimuli in the scene, make and/or execute a decision, initiate and/or complete an action, etc.), relatively small differences in compute/processing delays/latencies and costs can have a significant impact on AV operations.

For example, if an AV in a scene encounters an event that requires the AV to react quickly, the delay/latency of a compute path associated with a particular operation that the AV can perform to react to the event may exceed the amount of time the AV has to perform the operation or the amount of time available for the AV to initiate and complete the operation safely. As a result, the delay/latency of a compute path associated with an operation may limit the AV's ability to implement that operation in certain scenarios and/or may increase the risk of implementing that operation in such scenarios (e.g., because of a limited amount of time available to complete the operation in view of the estimated delay/latency associated with the operation). In many cases, the delays/latencies of compute paths associated with certain AV operations and/or the amount of time available to safely perform a particular operation can limit what operations an AV can safely perform in a given scenario.

In many cases, as the size of a compute path (e.g., the number of neural network nodes and/or layers in the compute path, the amount of code executed along the compute path, the amount of data processed along the compute path, etc.) associated with an AV operation and/or the complexity of the compute path (e.g., the complexity of neural network nodes and/or layers along the compute path, the complexity of code implemented by the compute path, the complexity of data processed along the compute path, the complexity of functions/operations executed along the compute path, etc.) associated with the AV operation increases/increase, the delay/latency in performing/completing the AV operation can also increase. Moreover, an increase in the delay/latency of the AV operation can limit the AV's ability to safely perform the AV operation, can increase the risk of performing the AV operation in a given scenario (e.g., in a scenario with a reduced amount of safe response/reaction time, a scenario without at least a threshold amount of time difference between a safe response/reaction time and a delay/latency of a response/reaction operation, etc.), and/or can even limit the number of available operations the AV can safely perform in a given scenario).

As previously noted, AV compute systems (e.g., deep learning models, neural networks, etc.) implemented by AVs are generally static and do not change compute paths when processing different data and/or scenes. In some cases, an AV compute system may include a first compute path as well as one or more second (e.g., alternate) compute paths that may provide different reaction times than the first compute path. The AV can select the first compute path or any of the one or more second compute paths to implement a particular operation associated with the first and second compute paths. However, the one or more second compute paths are also static, and often operated in parallel to the first compute path. Thus, the one or more second compute paths may not offer a desired reaction time (e.g., may have a delay/latency above a threshold and/or above a desired delay/latency). Moreover, the available compute paths (e.g., the first compute path and any second (e.g., alternate) compute path) are inflexible and may not be capable of accommodating (or may not be tuned or suitable for) different data, scenes, and/or performance parameters (e.g., reaction times, delays, latencies, etc.).

In typical compute system implementations, even when a compute path implemented only includes, involves, and/or activates a subset of nodes (also referred to as neurons herein) and/or layers of a neural network, the remaining, unused nodes (neurons) and/or layers of the neural network still use/utilize, occupy, and/or consume compute resources. Such usage/utilization, occupation, and/or consumption of compute resources by the remaining, unused nodes and/or layers of the neural network is inefficient/wasteful and unnecessarily increase the compute footprint and/or burden associated with that compute path.

For example, assume that a neural network is trained to detect multiple types of targets in a scene, such as humans and vehicles. In this example, the neural network may use/activate a first subset of neurons when performing human detection and a second subset of neurons when performing vehicle detection. The first subset of neurons and the second subset of neurons can be entirely different or can partially overlap. Here, when performing human detection, the neural network may activate the first subset of neurons and, when performing vehicle detection, the neural network may activate the second subset of neurons. Despite the neural network only using/activating the first subset of neurons when performing human detection, the second subset of neurons may still use/consume and/or activate compute resources even though the second subset of neurons is not used to perform human detection. Similarly, despite the neural network only using/activating the second subset of neurons when performing vehicle detection, the first subset of neurons may still use/consume and/or activate compute resources even though the first subset of neurons is not used to perform vehicle detection. The use/consumption of compute by the second subset of neurons when performing human detection as well as the use/consumption of compute by the first subset of neurons when performing vehicle detection are wasteful/inefficient and unnecessary.

Systems, apparatuses, processes (also referred to as methods), and computer-readable media (collectively referred to herein as “systems and techniques”) are described herein for learning compute paths that an AV can implement/execute to perform an operation(s), reduce or balance compute costs, and/or achieve faster reaction times. In some examples, the systems and techniques described herein can dynamically learn compute paths (e.g., paths within a neural network model such as paths of nodes and/or layers) for an operation(s) to determine, from the determined compute paths (e.g., the dynamically learned compute paths and any static or predetermined compute paths) associated with the operation(s), a particular compute path that is estimated to be suitable (or most suitable) for a particular scene, operation, input data, context, and/or any other factors. For example, the systems and techniques described herein can learn which neurons, layers, and/or any other elements of a neural network are used when performing a particular function/operation, and intelligently activate such neurons, layers, and/or other elements when performing such function/operation.

Moreover, when performing a particular function/operation, the systems and techniques described herein can intelligently deactivate neurons, layers, and/or other elements of a neural network that are not needed or used to perform the particular function/operation. For example, returning to the previous example where a neural network was trained to perform human and vehicle detection, assume that the neural network only uses/activates the first subset of neurons when performing human detection and only uses/activates the second subset of neurons when performing vehicle detection as previously explained. In this example, the systems and techniques described herein can learn that the neural network only needs to use/activate the first subset of neurons when performing human detection and the second subset of neurons when performing vehicle detection. In addition, the systems and techniques described herein can learn that the second subset of neurons are not used/activated when performing human detection, and the first subset of neurons are not used/activated when performing vehicle detection. To increase efficiency, reduce compute waste, increase performance, and reduce the compute footprint, the systems and techniques described herein can deactivate (and/or avoid using) the second subset of neurons when performing human detection, and deactivate (and/or avoid using) the first subset of neurons when performing vehicle detection.

In some cases, an AV can use the systems and techniques described herein to learn different paths along a neural network(s) of the AV. The AV can learn and/or select a particular compute path from various compute paths in order to perform a particular operation. For example, the systems and techniques described herein can use deep learning to learn compute paths along a neural network that a computing device of an AV can execute/traverse in order to perform a particular operation by the AV. The AV can select a specific path from the learned paths to perform the particular operation.

In some cases, the selected and/or learned compute path can include a compute path estimated to have a lower compute burden and/or delay/latency than other compute paths available to perform the particular operation or a similar operation. For example, the selected and/or learned compute path can allow the AV to perform a particular operation faster (e.g., with a lower delay/latency) than other compute paths and/or can use a smaller amount of compute resources than another compute path(s) without reducing an associated accuracy, safety, and/or performance beyond a threshold amount. To illustrate, a learned and selected compute path can include a path of neural network nodes and layers that can be traversed/executed to perform an operation faster than other alternative paths of neural network nodes and layers for performing the operation or another relevant/similar operation.

In some examples, the systems and techniques described herein can implement an early exit strategy to generate an intermediate output or perform a particular AV operation without traversing an entire compute path of a software system and/or model (e.g., a neural network or deep learning model) of an AV. In some cases, the systems and techniques described herein can implement a neural network with multiple neural network branches. The neural network can be configured to perform one or more operations and/or provide one or more functionalities. In some examples, the systems and techniques described herein can be used to select, from the neural network with multiple neural network branches, a particular branch (or branches) of the neural network to use (e.g., to traverse and/or execute) to generate an output and/or perform an operation at a lower delay/latency than otherwise traversing a different (e.g., longer, more complex, slower, etc.) path(s) along the neural network. For example, the systems and techniques described herein can select, from the neural network, a latency-stable branch (e.g., a branch that achieves a certain delay/latency or range of delays/latencies with a threshold consistency/frequency and/or in a threshold percentage/amount of cases/uses) to generate a particular output and/or perform a particular operation at a lower delay/latency than otherwise traversing a different neural network path or paths.

In some examples, the systems and techniques described herein can use a deep learning model to determine different types of compute paths (e.g., different paths of nodes and/or different sequences/orders of nodes) that can be used to perform an operation(s), and select a particular compute path from the different compute paths learned. The systems and techniques described herein can select the particular compute path based on one or more factors and/or criteria. For example, in some cases, the systems and techniques described herein can determine which of the compute paths that can be implemented to perform an operation(s) that results in a fastest reaction time (and/or lowest delay/latency) and/or has the more stable/predictable latency, and select the particular compute path associated with the fastest reaction time and/or the more stable/predictable latency. In some cases, the systems and techniques described herein can implement an early exit strategy for exiting a neural network prior to traversing all nodes along a particular path of the neural network, and/or prior to terminating or completing processing/data operations at a particular point within the neural network processing flow.

In some examples, the particular point within the neural network processing flow can include a point (e.g., a location within the neural network such as a node or layer, a point in time, a point within a predetermined end-to-end flow, etc.) prior to traversing an entire path of nodes (e.g., an entire static path identified for an associated operation, an end-to-end path identified for an associated operation, an entire predetermined path identified for an associated operation, etc.) along the neural network. In other examples, the particular point within the neural network processing flow can additionally or alternatively include a point (e.g., a point in time, a particular location within the neural network such as a node or layer, a point within a predetermined end-to-end flow, etc.) within the neural network or the neural network processing flow that is prior one or more functions of one or more nodes (e.g., that is reached prior to the one or more functions and/or one or more nodes being initiated and/or implemented, that is located along the neural network or the neural network processing flow and before the one or more functions are executed and/or completed, etc.) along a particular path of the neural network.

In some cases, the systems and techniques described herein can implement an early exit strategy that allows a computer of an autonomous vehicle to exit an AV compute system (e.g., a deep learning or neural network model implemented by an autonomous vehicle, an algorithm implemented by an autonomous vehicle, and/or a combination of models, neural networks, and/or algorithms) at an earlier time or processing point along a particular compute path of an operation. The systems and techniques described herein can implement the early exit in order to reduce the processing delay/latency and/or reaction time of the AV compute system.

The processing point associated with the exit strategy can include, for example and without limitation, a particular processing node along a path of nodes (e.g., the last node in the path, an exit or output node in the path, a node prior to a last node in the path, etc.) in the AV compute system, a particular layer within the AV compute system (and/or a path within the AV compute system), a particular function(s), a particular processing stage (e.g., an inference stage, an output stage, a feedback stage, etc.), a particular processing time and/or location within a processing path, etc. In some examples, the particular processing time and/or location within the processing path can include a processing time and/or location of an output expected from the AV compute system, a particular node or path of nodes associated with an output of the AV compute system, a point at which an output is derived by the AV compute system based on data processed by a set of nodes of the AV compute system, a particular processing workload, a particular data flow, etc.

To illustrate, in some examples, the systems and techniques described herein can implement a strategy for reducing a processing time/delay/latency/etc., by exiting a compute path in an AV compute system before traversing the entire compute path and/or implementing every element (e.g., every layer, every neuron, every function, every model branch or sub-path, every node, etc.) along the compute path. For example, the systems and techniques described herein can reduce a processing time, delay, and/or latency when performing an operation by exiting a compute path (e.g., in an AV compute system) for performing the operation or terminating processing of data using the compute path prior to traversing every element (e.g., every neuron, every layer, every function, every node, every model branch or sub-path, etc.) along the compute path, prior to activating/initiating every element along the compute path, prior to using every element along the compute path, prior to completing execution of one or more functions of one or more nodes along the compute path, prior to reaching or traversing a particular node along the compute path, prior to reaching or traversing a predetermined exit or output node along the compute path, prior to executing one or more functions of the predetermined exit or output node, prior to activating/initiating the predetermined exit or output node, prior to completing an action performed or triggered by the predetermined exit or output node, etc.

As previously explained, in some cases, the systems and techniques described herein can execute an early exit strategy for exiting a compute path of an AV compute system (e.g., a deep learning or neural network model implemented by an autonomous vehicle, an algorithm implemented by an autonomous vehicle, and/or a combination of models, neural networks, and/or algorithms) in order to reduce a processing time, a reaction time, a processing delay, a processing latency, a compute cost/footprint, a compute resource usage, etc., of the AV compute system. For example, the systems and techniques described herein can execute an early exit strategy that provides early termination of a processing flow and/or exits a compute path of an AV compute system early (e.g., prior to an estimated/expected, predetermined, configured, known, detected, set, and/or identified exit such as a final/exit node, layer, function, branch, neuron, etc.) to reduce a latency or delay of the AV compute system in performing one or more operations, reduce a response time of one or more operations by the AV compute system, achieve a more predictable/stable processing time and/or latency/delay, and/or increase a processing performance of the AV compute system. As previously noted, in some illustrative examples, the systems and techniques described herein can exit a compute path in the AV compute system prior to completing the compute path, prior to reaching/activating/initiating/etc., a last or exit element (e.g., node, layer, function, branch, neuron, etc.) of the compute path, prior to executing one or more functions of an element (e.g., a last or exit element, an intermediate element, etc.) of the compute path, etc.

In some cases, to execute an early exit strategy for exiting a compute path in an AV compute system, the systems and techniques described herein can discover/learn and change a first compute path implemented, selected, and/or configured by the AV compute system to a second (e.g., alternate) compute path in the AV compute system. In some examples, the second compute path can include or traverse certain neural network nodes that are not included or traversed in the first compute path of the AV compute system, certain neural network layers that are not included or traversed in the first compute path, one or more functions that are not implemented in the first compute path, one or more neural network model branches that are not included or traversed in the first compute path, and/or any other system elements (e.g., neural network or deep learning model elements) that are not included or traversed in the first compute path.

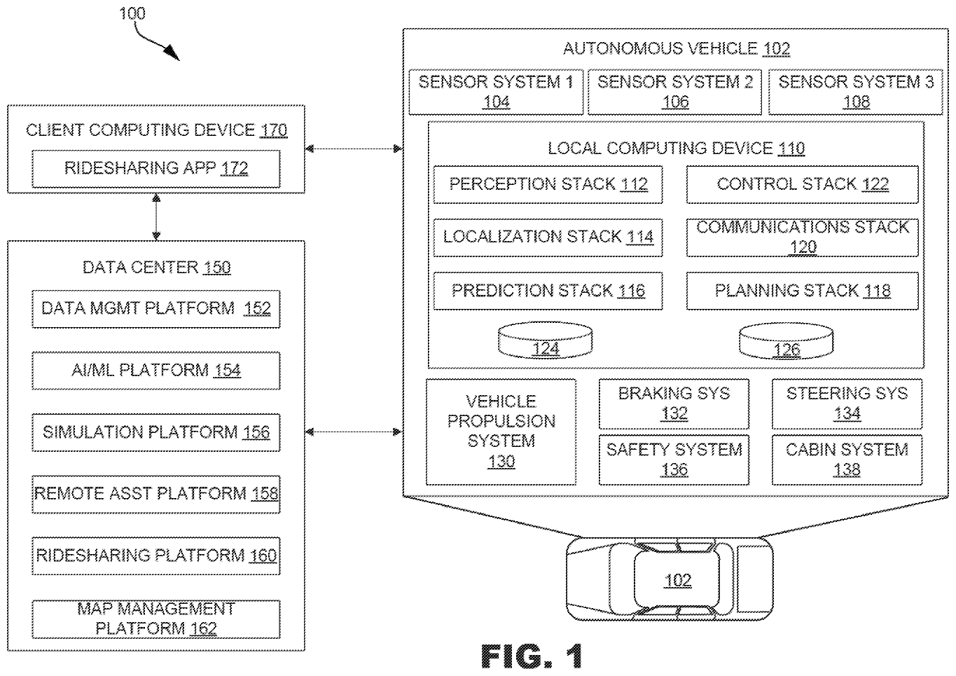

Examples of the systems and techniques described herein for processing data are illustrated in FIG. 1 through FIG. 8 and described below.

FIG. 1 is a diagram illustrating an example autonomous vehicle (AV) environment 100, according to some examples of the present disclosure. One of ordinary skill in the art will understand that, for the AV management system 100 and any system discussed in the present disclosure, there can be additional or fewer components in similar or alternative configurations. The illustrations and examples provided in the present disclosure are for conciseness and clarity. Other examples may include different numbers and/or types of elements, but one of ordinary skill the art will appreciate that such variations do not depart from the scope of the present disclosure.

In this example, the AV management system 100 includes an AV 102, a data center 150, and a client computing device 170. The AV 102, the data center 150, and the client computing device 170 can communicate with one another over one or more networks (not shown), such as a public network (e.g., the Internet, an Infrastructure as a Service (IaaS) network, a Platform as a Service (PaaS) network, a Software as a Service (SaaS) network, other Cloud Service Provider (CSP) network, etc.), a private network (e.g., a Local Area Network (LAN), a private cloud, a Virtual Private Network (VPN), etc.), and/or a hybrid network (e.g., a multi-cloud or hybrid cloud network, etc.).

The AV 102 can navigate roadways without a human driver based on sensor signals generated by sensor systems 104, 106, and 108. The sensor systems 104-108 can include one or more types of sensors and can be arranged about the AV 102. For instance, the sensor systems 104-108 can include Inertial Measurement Units (IMUs), cameras (e.g., still image cameras, video cameras, etc.), light sensors (e.g., LIDAR systems, ambient light sensors, infrared sensors, etc.), RADAR systems, GPS receivers, audio sensors (e.g., microphones, Sound Navigation and Ranging (SONAR) systems, ultrasonic sensors, etc.), engine sensors, speedometers, tachometers, odometers, altimeters, tilt sensors, impact sensors, airbag sensors, seat occupancy sensors, open/closed door sensors, tire pressure sensors, rain sensors, and so forth. For example, the sensor system 104 can be a camera system, the sensor system 106 can be a LIDAR system, and the sensor system 108 can be a RADAR system. Other examples may include any other number and type of sensors.

The AV 102 can also include several mechanical systems that can be used to maneuver or operate the AV 102. For instance, the mechanical systems can include a vehicle propulsion system 130, a braking system 132, a steering system 134, a safety system 136, and a cabin system 138, among other systems. The vehicle propulsion system 130 can include an electric motor, an internal combustion engine, or both. The braking system 132 can include an engine brake, brake pads, actuators, and/or any other suitable componentry configured to assist in decelerating the AV 102. The steering system 134 can include suitable componentry configured to control the direction of movement of the AV 102 during navigation. The safety system 136 can include lights and signal indicators, a parking brake, airbags, and so forth. The cabin system 138 can include cabin temperature control systems, in-cabin entertainment systems, and so forth. In some examples, the AV 102 might not include human driver actuators (e.g., steering wheel, handbrake, foot brake pedal, foot accelerator pedal, turn signal lever, window wipers, etc.) for controlling the AV 102. Instead, the cabin system 138 can include one or more client interfaces (e.g., Graphical User Interfaces (GUIs), Voice User Interfaces (VUIs), etc.) for controlling certain aspects of the mechanical systems 130-138.

The AV 102 can include a local computing device 110 that is in communication with the sensor systems 104-108, the mechanical systems 130-138, the data center 150, and/or the client computing device 170, among other systems. The local computing device 110 can include one or more processors and memory, including instructions that can be executed by the one or more processors. The instructions can make up one or more software stacks or components responsible for controlling the AV 102; communicating with the data center 150, the client computing device 170, and other systems; receiving inputs from riders, passengers, and other entities within the AV's environment; logging metrics collected by the sensor systems 104-108; and so forth. In this example, the local computing device 110 includes a perception stack 112, a mapping and localization stack 114, a prediction stack 116, a planning stack 118, a communications stack 120, a control stack 122, an AV operational database 124, and an HD geospatial database 126, among other stacks and systems.

The perception stack 112 can enable the AV 102 to “see” (e.g., via cameras, LIDAR sensors, infrared sensors, etc.), “hear” (e.g., via microphones, ultrasonic sensors, RADAR, etc.), and “feel” (e.g., pressure sensors, force sensors, impact sensors, etc.) its environment using information from the sensor systems 104-108, the mapping and localization stack 114, the HD geospatial database 126, other components of the AV, and/or other data sources (e.g., the data center 150, the client computing device 170, third party data sources, etc.). The perception stack 112 can detect and classify objects and determine their current locations, speeds, directions, and the like. In addition, the perception stack 112 can determine the free space around the AV 102 (e.g., to maintain a safe distance from other objects, change lanes, park the AV, etc.). The perception stack 112 can identify environmental uncertainties, such as where to look for moving objects, flag areas that may be obscured or blocked from view, and so forth. In some examples, an output of the prediction stack can be a bounding area around a perceived object that can be associated with a semantic label that identifies the type of object that is within the bounding area, the kinematic of the object (information about its movement), a tracked path of the object, and a description of the pose of the object (its orientation or heading, etc.).

The mapping and localization stack 114 can determine the AV's position and orientation (pose) using different methods from multiple systems (e.g., GPS, IMUs, cameras, LIDAR, RADAR, ultrasonic sensors, the HD geospatial database 126, etc.). For example, in some cases, the AV 102 can compare sensor data captured in real-time by the sensor systems 104-108 to data in the HD geospatial database 126 to determine its precise (e.g., accurate to the order of a few centimeters or less) position and orientation. The AV 102 can focus its search based on sensor data from one or more first sensor systems (e.g., GPS) by matching sensor data from one or more second sensor systems (e.g., LIDAR). If the mapping and localization information from one system is unavailable, the AV 102 can use mapping and localization information from a redundant system and/or from remote data sources.

The prediction stack 116 can receive information from the localization stack 114 and objects identified by the perception stack 112 and predict a future path for the objects. In some examples, the prediction stack 116 can output several likely paths that an object is predicted to take along with a probability associated with each path. For each predicted path, the prediction stack 116 can also output a range of points along the path corresponding to a predicted location of the object along the path at future time intervals along with an expected error value for each of the points that indicates a probabilistic deviation from that point.

The planning stack 118 can determine how to maneuver or operate the AV 102 safely and efficiently in its environment. For example, the planning stack 118 can receive the location, speed, and direction of the AV 102, geospatial data, data regarding objects sharing the road with the AV 102 (e.g., pedestrians, bicycles, vehicles, ambulances, buses, cable cars, trains, traffic lights, lanes, road markings, etc.) or certain events occurring during a trip (e.g., emergency vehicle blaring a siren, intersections, occluded areas, street closures for construction or street repairs, double-parked cars, etc.), traffic rules and other safety standards or practices for the road, user input, and other relevant data for directing the AV 102 from one point to another and outputs from the perception stack 112, localization stack 114, and prediction stack 116. The planning stack 118 can determine multiple sets of one or more mechanical operations that the AV 102 can perform (e.g., go straight at a specified rate of acceleration, including maintaining the same speed or decelerating; turn on the left blinker, decelerate if the AV is above a threshold range for turning, and turn left; turn on the right blinker, accelerate if the AV is stopped or below the threshold range for turning, and turn right; decelerate until completely stopped and reverse; etc.), and select the best one to meet changing road conditions and events. If something unexpected happens, the planning stack 118 can select from multiple backup plans to carry out. For example, while preparing to change lanes to turn right at an intersection, another vehicle may aggressively cut into the destination lane, making the lane change unsafe. The planning stack 118 could have already determined an alternative plan for such an event. Upon its occurrence, it could help direct the AV 102 to go around the block instead of blocking a current lane while waiting for an opening to change lanes.

The control stack 122 can manage the operation of the vehicle propulsion system 130, the braking system 132, the steering system 134, the safety system 136, and the cabin system 138. The control stack 122 can receive sensor signals from the sensor systems 104-108 as well as communicate with other stacks or components of the local computing device 110 or a remote system (e.g., the data center 150) to effectuate operation of the AV 102. For example, the control stack 122 can implement the final path or actions from the multiple paths or actions provided by the planning stack 118. This can involve turning the routes and decisions from the planning stack 118 into commands for the actuators that control the AV's steering, throttle, brake, and drive unit.

The communications stack 120 can transmit and receive signals between the various stacks and other components of the AV 102 and between the AV 102, the data center 150, the client computing device 170, and other remote systems. The communications stack 120 can enable the local computing device 110 to exchange information remotely over a network, such as through an antenna array or interface that can provide a metropolitan WIFI network connection, a mobile or cellular network connection (e.g., Third Generation (3G), Fourth Generation (4G), Long-Term Evolution (LTE), 5th Generation (5G), etc.), and/or other wireless network connection (e.g., License Assisted Access (LAA), Citizens Broadband Radio Service (CBRS), MULTEFIRE, etc.). The communications stack 120 can also facilitate the local exchange of information, such as through a wired connection (e.g., a user's mobile computing device docked in an in-car docking station or connected via Universal Serial Bus (USB), etc.) or a local wireless connection (e.g., Wireless Local Area Network (WLAN), Bluetooth®, infrared, etc.).

The HD geospatial database 126 can store HD maps and related data of the streets upon which the AV 102 travels. In some examples, the HD maps and related data can comprise multiple layers, such as an areas layer, a lanes and boundaries layer, an intersections layer, a traffic controls layer, and so forth. The areas layer can include geospatial information indicating geographic areas that are drivable (e.g., roads, parking areas, shoulders, etc.) or not drivable (e.g., medians, sidewalks, buildings, etc.), drivable areas that constitute links or connections (e.g., drivable areas that form the same road) versus intersections (e.g., drivable areas where two or more roads intersect), and so on. The lanes and boundaries layer can include geospatial information of road lanes (e.g., lane centerline, lane boundaries, type of lane boundaries, etc.) and related attributes (e.g., direction of travel, speed limit, lane type, etc.). The lanes and boundaries layer can also include three-dimensional (3D) attributes related to lanes (e.g., slope, elevation, curvature, etc.). The intersections layer can include geospatial information of intersections (e.g., crosswalks, stop lines, turning lane centerlines and/or boundaries, etc.) and related attributes (e.g., permissive, protected/permissive, or protected only left turn lanes; legal or illegal u-turn lanes; permissive or protected only right turn lanes; etc.). The traffic controls lane can include geospatial information of traffic signal lights, traffic signs, and other road objects and related attributes.

The AV operational database 124 can store raw AV data generated by the sensor systems 104-108, stacks 112-122, and other components of the AV 102 and/or data received by the AV 102 from remote systems (e.g., the data center 150, the client computing device 170, etc.). In some examples, the raw AV data can include HD LIDAR point cloud data, image data, RADAR data, GPS data, and other sensor data that the data center 150 can use for creating or updating AV geospatial data or for creating simulations of situations encountered by AV 102 for future testing or training of various machine learning algorithms that are incorporated in the local computing device 110.

The data center 150 can include a private cloud (e.g., an enterprise network, a co-location provider network, etc.), a public cloud (e.g., an Infrastructure as a Service (IaaS) network, a Platform as a Service (PaaS) network, a Software as a Service (SaaS) network, or other Cloud Service Provider (CSP) network), a hybrid cloud, a multi-cloud, and/or any other network. The data center 150 can include one or more computing devices remote to the local computing device 110 for managing a fleet of AVs and AV-related services. For example, in addition to managing the AV 102, the data center 150 may also support a ridesharing service, a delivery service, a remote/roadside assistance service, street services (e.g., street mapping, street patrol, street cleaning, street metering, parking reservation, etc.), and the like.

The data center 150 can send and receive various signals to and from the AV 102 and the client computing device 170. These signals can include sensor data captured by the sensor systems 104-108, roadside assistance requests, software updates, ridesharing pick-up and drop-off instructions, and so forth. In this example, the data center 150 includes a data management platform 152, an Artificial Intelligence/Machine Learning (AI/ML) platform 154, a simulation platform 156, a remote assistance platform 158, and a ridesharing platform 160, and a map management platform 162, among other systems.

The data management platform 152 can be a “big data” system capable of receiving and transmitting data at high velocities (e.g., near real-time or real-time), processing a large variety of data and storing large volumes of data (e.g., terabytes, petabytes, or more of data). The varieties of data can include data having different structures (e.g., structured, semi-structured, unstructured, etc.), data of different types (e.g., sensor data, mechanical system data, ridesharing service, map data, audio, video, etc.), data associated with different types of data stores (e.g., relational databases, key-value stores, document databases, graph databases, column-family databases, data analytic stores, search engine databases, time series databases, object stores, file systems, etc.), data originating from different sources (e.g., AVs, enterprise systems, social networks, etc.), data having different rates of change (e.g., batch, streaming, etc.), and/or data having other characteristics. The various platforms and systems of the data center 150 can access data stored by the data management platform 152 to provide their respective services.

The AI/ML platform 154 can provide the infrastructure for training and evaluating machine learning algorithms for operating the AV 102, the simulation platform 156, the remote assistance platform 158, the ridesharing platform 160, the map management platform 162, and other platforms and systems. Using the AI/ML platform 154, data scientists can prepare data sets from the data management platform 152; select, design, and train machine learning models; evaluate, refine, and deploy the models; maintain, monitor, and retrain the models; and so on.

The simulation platform 156 can enable testing and validation of the algorithms, machine learning models, neural networks, and other development efforts for the AV 102, the remote assistance platform 158, the ridesharing platform 160, the map management platform 162, and other platforms and systems. The simulation platform 156 can replicate a variety of driving environments and/or reproduce real-world scenarios from data captured by the AV 102, including rendering geospatial information and road infrastructure (e.g., streets, lanes, crosswalks, traffic lights, stop signs, etc.) obtained from the map management platform 162 and/or a cartography platform; modeling the behavior of other vehicles, bicycles, pedestrians, and other dynamic elements; simulating inclement weather conditions, different traffic scenarios; and so on.

The remote assistance platform 158 can generate and transmit instructions regarding the operation of the AV 102. For example, in response to an output of the AI/ML platform 154 or other system of the data center 150, the remote assistance platform 158 can prepare instructions for one or more stacks or other components of the AV 102.

The ridesharing platform 160 can interact with a customer of a ridesharing service via a ridesharing application 172 executing on the client computing device 170. The client computing device 170 can be any type of computing system such as, for example and without limitation, a server, desktop computer, laptop computer, tablet computer, smartphone, smart wearable device (e.g., smartwatch, smart eyeglasses or other Head-Mounted Display (HMD), smart ear pods, or other smart in-ear, on-ear, or over-ear device, etc.), gaming system, or any other computing device for accessing the ridesharing application 172. In some cases, the client computing device 170 can be a customer's mobile computing device or a computing device integrated with the AV 102 (e.g., the local computing device 110). The ridesharing platform 160 can receive requests to pick up or drop off from the ridesharing application 172 and dispatch the AV 102 for the trip.

Map management platform 162 can provide a set of tools for the manipulation and management of geographic and spatial (geospatial) and related attribute data. The data management platform 152 can receive LIDAR point cloud data, image data (e.g., still image, video, etc.), RADAR data, GPS data, and other sensor data (e.g., raw data) from one or more AVs 102, Unmanned Aerial Vehicles (Ues), satellites, third-party mapping services, and other sources of geospatially referenced data. The raw data can be processed, and map management platform 162 can render base representations (e.g., tiles (2D), bounding volumes (3D), etc.) of the AV geospatial data to enable users to view, query, label, edit, and otherwise interact with the data. Map management platform 162 can manage workflows and tasks for operating on the AV geospatial data. Map management platform 162 can control access to the AV geospatial data, including granting or limiting access to the AV geospatial data based on user-based, role-based, group-based, task-based, and other attribute-based access control mechanisms. Map management platform 162 can provide version control for the AV geospatial data, such as to track specific changes that (human or machine) map editors have made to the data and to revert changes when necessary. Map management platform 162 can administer release management of the AV geospatial data, including distributing suitable iterations of the data to different users, computing devices, AVs, and other consumers of HD maps. Map management platform 162 can provide analytics regarding the AV geospatial data and related data, such as to generate insights relating to the throughput and quality of mapping tasks.

In some examples, the map viewing services of map management platform 162 can be modularized and deployed as part of one or more of the platforms and systems of the data center 150. For example, the AI/ML platform 154 may incorporate the map viewing services for visualizing the effectiveness of various object detection or object classification models, the simulation platform 156 may incorporate the map viewing services for recreating and visualizing certain driving scenarios, the remote assistance platform 158 may incorporate the map viewing services for replaying traffic incidents to facilitate and coordinate aid, the ridesharing platform 160 may incorporate the map viewing services into the client application 172 to enable passengers to view the AV 102 in transit to a pick-up or drop-off location, and so on.

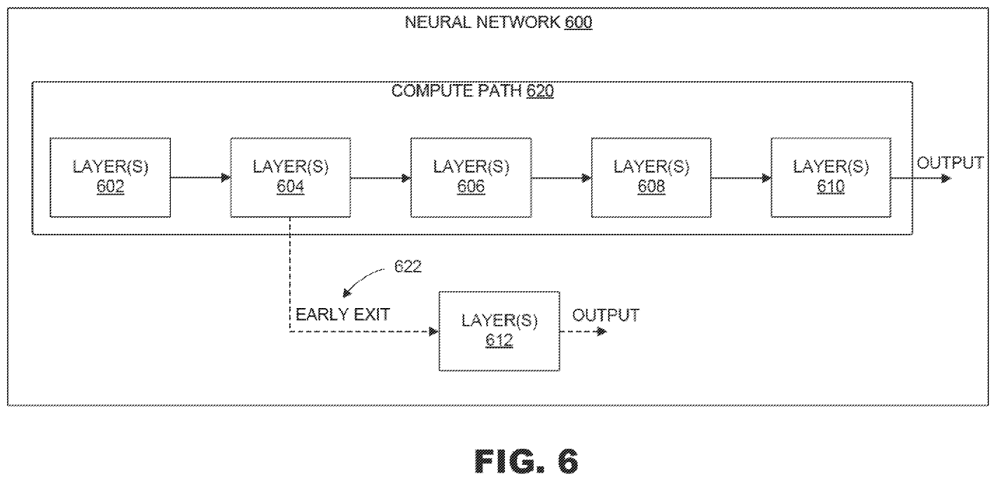

While the AV 102, the local computing device 110, and the autonomous vehicle environment 100 are shown to include certain systems and components, one of ordinary skill will appreciate that the AV 102, the local computing device 110, and/or the autonomous vehicle environment 100 can include more or fewer systems and/or components than those shown in FIG. 1. For example, the AV 102 can include other services than those shown in FIG. 1 and the local computing device 110 can also include, in some instances, one or more memory devices (e.g., RAM, ROM, cache, and/or the like), one or more network interfaces (e.g., wired and/or wireless communications interfaces and the like), and/or other hardware or processing devices that are not shown in FIG. 1. An illustrative example of a computing device and hardware components that can be implemented with the local computing device 110 is described below with respect to FIG. 6.

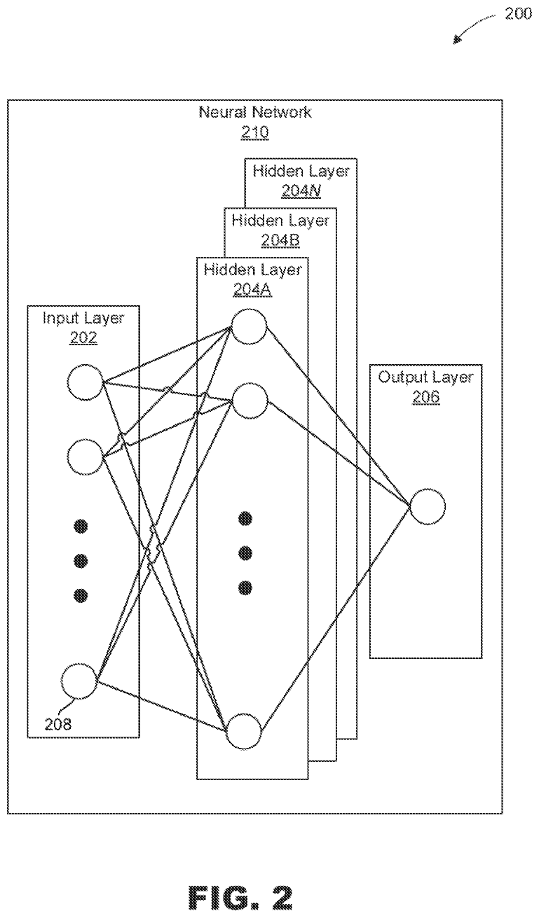

FIG. 2 illustrates an example configuration 200 of a neural network 210 that can be implemented by a computer of AV 102, such as the local computing device 110. The example configuration 200 is merely one illustrative example provided for clarity and explanation purposes. One of ordinary skill in the art will recognize that other configurations of a neural network are also possible and contemplated herein.

In this example, the neural network 210 includes an input layer 202 which includes input data. The input data can include sensor data such as, for example, image data (e.g., video frames, still images, etc.) from one or more image sensors, LIDAR data from one or more LIDARs, and/or any other type of sensor data. The input data can capture or depict a view, scene, environment, shape, and/or object. For example, in some cases, the input data can depict a scene associated with the AV 102. In one illustrative example, the input layer 202 can include data representing the pixels of one or more input images depicting an environment of the AV 102.

The neural network 210 includes hidden layers 204A through 204N (collectively “204” hereinafter). The hidden layers 204 can include n number of hidden layers, where n is an integer greater than or equal to one. The number of hidden layers can be made to include as many layers as needed for the given application. The neural network 210 further includes an output layer 206 that provides an output resulting from the processing performed by the hidden layers 204. In one illustrative example, the output layer 206 can provide a classification and/or localization of one or more objects in an input image. The classification can include a class identifying the type of object or scene (e.g., a car, a pedestrian, an animal, a train, an object, or any other object or scene). In some cases, a localization can include a bounding box indicating the location of an object or scene.

The neural network 210 is a multi-layer deep learning network of interconnected nodes. Each node can represent a piece of information. Information associated with the nodes is shared among the different layers and each layer retains information as information is processed. In some cases, the neural network 210 can include a feed-forward network, in which case there are no feedback connections where outputs of the network are fed back into itself. In some cases, the neural network 210 can include a recurrent neural network, which can have loops that allow information to be carried across nodes while reading in input.

Information can be exchanged between nodes through node-to-node interconnections between the various layers. Nodes of the input layer 202 can activate a set of nodes in the first hidden layer 204A. For example, as shown, each of the input nodes of the input layer 202 is connected to each of the nodes of the first hidden layer 204A. The nodes of the hidden layer 204A can transform the information of each input node by applying activation functions to the information. The information derived from the transformation can then be passed to and can activate the nodes of the next hidden layer (e.g., 204B), which can perform their own designated functions. Example functions include convolutional, up-sampling, data transformation, pooling, and/or any other suitable functions. The output of the hidden layer (e.g., 204B) can then activate nodes of the next hidden layer (e.g., 204N), and so on. The output of the last hidden layer can activate one or more nodes of the output layer 206, at which point an output is provided. In some cases, while nodes (e.g., node 208) in the neural network 210 are shown as having multiple output lines, a node has a single output and all lines shown as being output from a node represent the same output value.

In some cases, each node or interconnection between nodes can have a weight that is a set of parameters derived from the training of the neural network 210. For example, an interconnection between nodes can represent a piece of information learned about the interconnected nodes. The interconnection can have a numeric weight that can be tuned (e.g., based on a training dataset), allowing the neural network 210 to be adaptive to inputs and able to learn as more data is processed.

The neural network 210 can be pre-trained to process the features from the data in the input layer 202 using the different hidden layers 204 in order to provide the output through the output layer 206. In an example in which the neural network 210 is used to identify objects or features in images, the neural network 210 can be trained using training data that includes images and/or labels. For instance, training images can be input into the neural network 210, with each training image having a label indicating the classes of the one or more objects or features in each image (e.g., indicating to the network what the objects are and what features they have).

In some cases, the neural network 210 can adjust the weights of the nodes using a training process called backpropagation. Backpropagation can include a forward pass, a loss function, a backward pass, and a weight update. The forward pass, loss function, backward pass, and parameter update is performed for one training iteration. The process can be repeated for a certain number of iterations for each set of training images until the neural network 210 is trained enough so that the weights of the layers are accurately tuned.

For the example of identifying objects in images, the forward pass can include passing a training image through the neural network 210. The weights can be initially randomized before the neural network 210 is trained. The image can include, for example, an array of numbers representing the pixels of the image. Each number in the array can include a value from 0 to 255 describing the pixel intensity at that position in the array. In one example, the array can include a 28×28×3 array of numbers with 28 rows and 28 columns of pixels and 3 color components (such as red, green, and blue, or luma and two chroma components, or the like).

For a first training iteration for the neural network 210, the output can include values that do not give preference to any particular class due to the weights being randomly selected at initialization. For example, if the output is a vector with probabilities that the object includes different classes, the probability value for each of the different classes may be equal or at least very similar (e.g., for ten possible classes, each class may have a probability value of 0.1). With the initial weights, the neural network 210 is unable to determine low level features and thus cannot make an accurate determination of what the classification of the object might be. A loss function can be used to analyze errors in the output. Any suitable loss function definition can be used.

The loss (or error) can be high for the first training images since the actual values will be different than the predicted output. The goal of training is to minimize the amount of loss so that the predicted output is the same as the training label. The neural network 210 can perform a backward pass by determining which inputs (weights) most contributed to the loss of the network, and can adjust the weights so that the loss decreases and is eventually minimized.

A derivative of the loss with respect to the weights can be computed to determine the weights that contributed most to the loss of the network. After the derivative is computed, a weight update can be performed by updating the weights of the filters. For example, the weights can be updated so that they change in the opposite direction of the gradient. A learning rate can be set to any suitable value, with a high learning rate including larger weight updates and a lower value indicating smaller weight updates.

The neural network 210 can include any suitable deep network. One example includes a convolutional neural network (CNN), which includes an input layer and an output layer, with multiple hidden layers between the input and out layers. The hidden layers of a CNN include a series of convolutional, nonlinear, pooling (e.g., for down sampling), and fully connected layers. In other examples, the neural network 210 can represent any other deep network other than a CNN, such as an autoencoder, a deep belief nets (DBNs), a Recurrent Neural Networks (RNNs), etc.

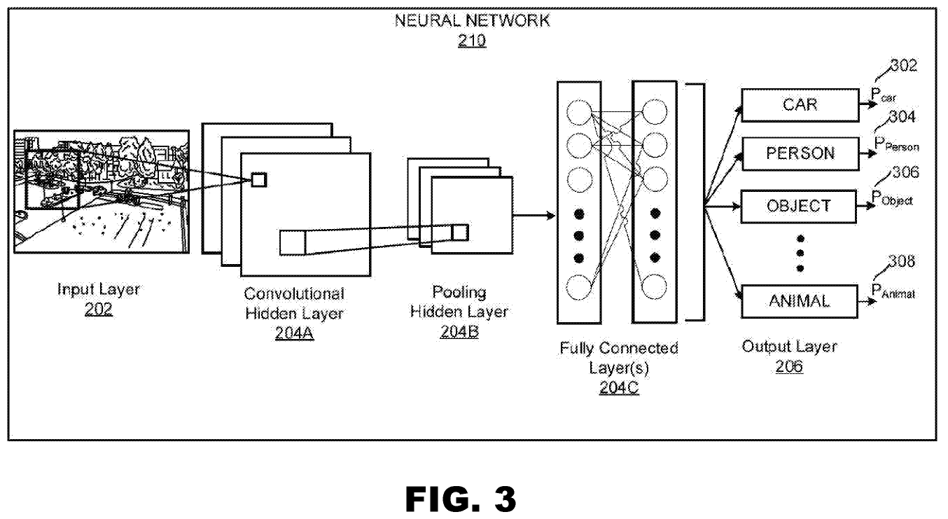

FIG. 3 illustrates an example use of neural network 210 configured to perform deep learning. The example use of the neural network 210 is merely one illustrative example provided for clarity and explanation purposes. One of ordinary skill in the art will recognize that other uses of the neural network 210 are also possible and contemplated herein.

In this example, the neural network 210 includes an input layer 202, a convolutional hidden layer 204A, a pooling hidden layer 204B, fully connected layers 204C, and output layer 206. The neural network 210 can identify specific object, scene, and/or environment features (e.g., a car, an elevator, a train, a vessel, a road, bike paths, a lake, a park, a building, a pedestrian, an animal, etc.) in an image. First, each pixel in the image is considered as a neuron that has learnable weights and biases. Each neuron receives some inputs, performs a dot product and optionally follows it with a non-linearity function. The neural network 210 can also encode certain properties into the architecture by expressing a single differentiable score function from the raw image pixels on one end to class scores at the other to extract specific features from the image. After identifying objects in the image as specific features of an object, mobile platform or environment, the neural network 210 can generate a mean score (or z-score) of each feature and take the average of the scores within the user-defined buffer.

In some examples, the input layer 204A includes data representing an image. For example, the data can include an array of numbers representing the pixels of the image, with each number in the array including a value from 0 to 255 describing the pixel intensity at that position in the array. The image can be passed through the convolutional hidden layer 204A, an optional non-linear activation layer, a pooling hidden layer 204B, and fully connected hidden layers 206 to get an output at the output layer 206. The outputs 302, 304, 306, 308 can indicate a class of an object or a probability of classes that best describes the objects in the image.

The convolutional hidden layer 204A can analyze the image data of the input layer 202A. Each node of the convolutional hidden layer 204A can be connected to a region of nodes (pixels) of the input image. The convolutional hidden layer 204A can be considered as one or more filters (each filter corresponding to a different activation or feature map), with each convolutional iteration of a filter being a node or neuron of the convolutional hidden layer 204A. Each connection between a node and a receptive field (region of nodes (pixels)) for that node learns a weight and, in some cases, an overall bias such that each node learns to analyze its particular local receptive field in the input image.

The convolutional nature of the convolutional hidden layer 204A is due to each node of the convolutional layer being applied to its corresponding receptive field. For example, a filter of the convolutional hidden layer 204A can begin in the top-left corner of the input image array and can convolve around the input image. As noted above, each convolutional iteration of the filter can be considered a node or neuron of the convolutional hidden layer 204A. At each convolutional iteration, the values of the filter are multiplied with a corresponding number of the original pixel values of the image. The multiplications from each convolutional iteration can be summed together to obtain a total sum for that iteration or node. The process is next continued at a next location in the input image according to the receptive field of a next node in the convolutional hidden layer 204A. Processing the filter at each unique location of the input volume produces a number representing the filter results for that location, resulting in a total sum value being determined for each node of the convolutional hidden layer 204A.

The mapping from the input layer 202 to the convolutional hidden layer 204A can be referred to as an activation map (or feature map). The activation map includes a value for each node representing the filter results at each location of the input volume. The activation map can include an array that includes the various total sum values resulting from each iteration of the filter on the input volume. The convolutional hidden layer 204A can include several activation maps in order to identify multiple features in an image. The example shown in FIG. 3 includes three activation maps. Using three activation maps, the convolutional hidden layer 204A can detect three different kinds of features, with each feature being detectable across the entire image.

In some examples, a non-linear hidden layer can be applied after the convolutional hidden layer 204A. The non-linear layer can be used to introduce non-linearity to a system that has been computing linear operations.

The pooling hidden layer 204B can be applied after the convolutional hidden layer 204A (and after the non-linear hidden layer when used). The pooling hidden layer 204B is used to simplify the information in the output from the convolutional hidden layer 204A. For example, the pooling hidden layer 204B can take each activation map output from the convolutional hidden layer 204A and generate a condensed activation map (or feature map) using a pooling function. Max-pooling is one example of a function performed by a pooling hidden layer. Other forms of pooling functions be used by the pooling hidden layer 204B, such as average pooling or other suitable pooling functions. A pooling function (e.g., a max-pooling filter) is applied to each activation map included in the convolutional hidden layer 204A. In the example shown in FIG. 3, three pooling filters are used for the three activation maps in the convolutional hidden layer 204A.

The pooling function (e.g., max-pooling) can determine whether a given feature is found anywhere in a region of the image, and discard the exact positional information. This can be done without affecting results of the feature detection because, once a feature has been found, the exact location of the feature is not as important as its approximate location relative to other features. Max-pooling (as well as other pooling methods) offer the benefit that there are fewer pooled features, thus reducing the number of parameters needed in later layers.

The fully connected layer 204C can connect every node from the pooling hidden layer 204B to every output node in the output layer 206. The fully connected layer 204C can obtain the output of the previous pooling layer 204B (which should represent the activation maps of high-level features) and determine the features that correlate to a particular class. For example, the fully connected layer 204C layer can determine the high-level features that most strongly correlate to a particular class, and can include weights (nodes) for the high-level features. A product can be computed between the weights of the fully connected layer 204C and the pooling hidden layer 204B to obtain probabilities for the different classes.

In some examples, the output from the output layer 206 can include an n-dimensional vector, where n can include the number of classes that the program has to choose from when classifying the object or mobile platform in the image. Other example outputs can also be provided. Each number in the n-dimensional vector can represent the probability the object is of a certain class.

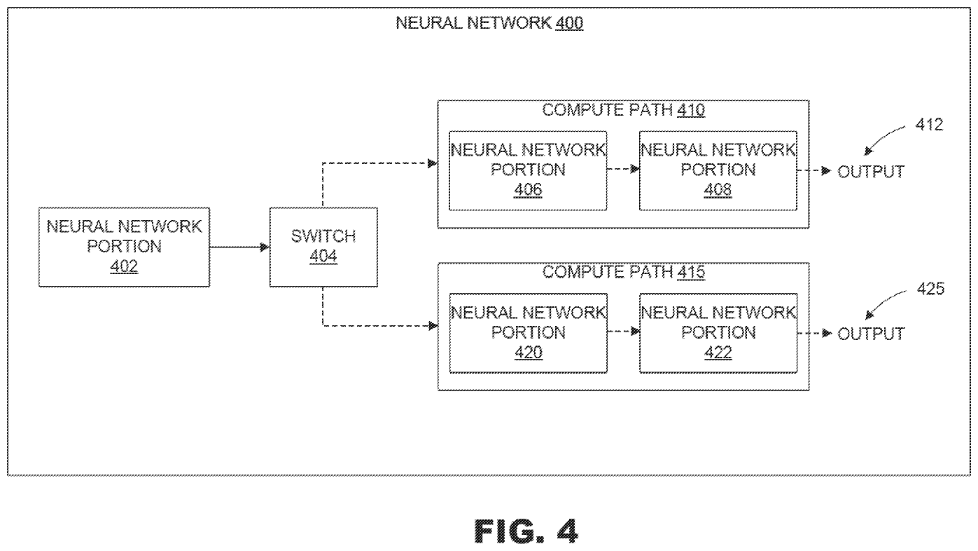

FIG. 4 is a diagram illustrating example compute paths of a neural network 400 learned in accordance with some examples of the present disclosure. The neural network 400 includes a neural network portion 402 configured to process input data such as, for example and without limitation, image data, sensor data, and/or any other type of input data. In some examples, the neural network portion 402 can include a layer of the neural network 400. In some cases, the neural network portion 402 can additionally or alternatively include one or more neurons of the neural network 400. In other examples, the neural network portion 402 can include a branch of the neural network 400 or a neural network model associated with the neural network 400.

In some cases, the neural network 400 or a separate neural network (not shown) can determine or learn the compute path 410 for processing data and/or outputs from the neural network portion 402. Moreover, the neural network 400 or a separate neural network can determine or learn to use the compute path 410 to perform a certain operation(s) implemented using data from the neural network portion 402. The compute path 410 can include, for example and without limitation, one or more neural network neurons, one or more neural network layers, one or more neural network branches, one or more neural network models, and/or one or more other neural network elements.

In the example shown in FIG. 4, the compute path 410 can include neural network portion 406 and neural network portion 408. In other examples, the compute path 410 can include more or less neural network portions. Each of the neural network portion 406 and the neural network portion 408 can include, for example, one or more neural network layers, one or more neural network neurons, one or more neural network branches, one or more neural network models, and/or one or more other neural network elements. In some examples, the neural network 400 or another neural network (not shown) can learn the compute path 410 based on data processed by the neural network 400 and/or operations performed by the neural network 400. For example, the compute path 410 can be learned by determining which portions of the neural network 400 are activated to perform a particular operation(s), which portions of the neural network 400 are used to process data/outputs from the neural network portion 402, and/or which portions of the neural network 400 are used to process certain scene features processed by the neural network portion 402.

In the example shown in FIG. 4, the neural network 400 also includes a compute path 415 used to perform the same operation(s) and/or process the same data and/or features as the compute path 410. For example, the compute path 410 and the compute path 415 can be configured to process the same or similar data and/or perform the same or similar operation(s). However, the compute path 415 may have a smaller size than the compute path 410, a smaller compute footprint than the compute path 410, a faster performance than the compute path 410, and/or a smaller latency than the compute path 410. On the other hand, the compute path 410 may have a higher output quality than the compute path 415, a higher output resolution than the compute path 415, and/or a higher output performance than the compute path 415. Thus, the compute path 410 and the compute path 415 can offer different balances of latency, compute footprint/burden, performance, speed, and/or output quality.

In some cases, the local computing device 110 of the AV 102 can choose to use the compute path 410 to process data from the neural network portion 402. However, as further described herein, in other cases, the local computing device 110 of the AV 102 can choose to use the compute path 415 to process data from the neural network portion 402, as the compute path 415 may provide a lower latency, faster reaction time (e.g., based on a processing speed of the compute path 415 relative to a processing speed of the compute path 410. The local computing device 110 can select between using the compute path 410 or the compute path 415 based on a desired trade-off or balance between latency, safety, speed, accuracy, and/or compute costs/footprint, as further described herein.

The compute path 415 can include neural network portion 420 and neural network portion 422. In other examples, the compute path 415 can include more or less neural network portions. Each of the neural network portion 420 and the neural network portion 422 can include, for example, one or more neural network layers, one or more neural network neurons, one or more neural network branches, one or more neural network models, and/or one or more other neural network elements. In some cases, the compute path 415 can include a version of the compute path 410 and/or a compute path created based on the compute path 410.

For example, the compute path 415 can include a downsized version of the compute path 410. As another example, the neural network portion 420 and the neural network portion 422 of the compute path 415 can include downsized versions of the neural network portion 406 and the neural network portion 408 of the compute path 410. In some cases, the downsized version of the compute path 410 (e.g., the compute path 415) can be created by downsizing a copy of the compute path 410. The compute path 410 can be downsized by pruning at least a portion of the compute path 410, quantizing (or otherwise compressing) the compute path 410, reducing a size of blocks/layers of the compute path 410, and/or any other downsizing techniques. To illustrate, the downsized version of the compute path 410 (e.g., the compute path 415) can be created by pruning a portion(s) of the compute path 410, such as pruning one or more layers, neurons, and/or neural network elements; quantizing (or otherwise compressing) the compute path 410; and/or reducing a size of blocks/layers of the compute path 410.

In some cases, the compute path 415 can include a portion of the neural network 400 trained using a cluster of scene features determined and/or processed by the neural network portion 402. For example, the compute path 410 can include a portion of the neural network 400 trained using a cluster(s) of scene features associated with an output of the neural network portion 402, and the compute path 415 can include a portion of the neural network 400 trained using a smaller set of clustered scene features associated with an output of the neural network portion 402, such as clustered scene features having a higher similarity than at least some of the clustered scene features used to train the compute path 410 and/or having a threshold similarity.

The neural network 400 can include a switch 404 used to determine whether an output from the neural network portion 402 should be processed using the compute path 410 or the compute path 415. For example, the switch 404 can analyze an output of the neural network portion 402 to determine whether the output should be further processed by the compute path 410 or the compute path 415. The switch 404 can include, for example and without limitation, a separate neural network model (e.g., separate from the neural network 400), a branch of the neural network 400, a portion of the neural network 400 (e.g., a neuron(s), a layer(s), etc.), a software application, an algorithm, a piece of code, and/or a script. The switch 404 can determine whether to process the output from the neural network portion 402 through the compute path 410 or the compute path 415 based on one or more factors such as, for example, a processing latency and/or speed, a compute load/burden associated with the compute path 410 and the compute path 415, a quality and/or accuracy of an output(s) of the compute path 410 and an output(s) of the compute path 415, and/or one or more other factors.

In some examples, the switch 404 can determine whether to process the output from the neural network portion 402 through the compute path 410 or the compute path 415 based on an expected error decrease (EED) associated with the compute path 410 and/or the compute path 415. The EED can indicate an error reduction (and/or quality improvement) in an output 412 of the compute path 410 relative to (and/or compared to) an output 425 of the compute path 415. In other words, the EED can indicate how much of an error reduction is achieved when implementing the compute path 410 (which is larger and/or more robust than the compute path 415) to process an output from the neural network portion 402 and/or perform an operation(s) using data from the neural network portion 402, as opposed to when implementing the compute path 415. For example, in some cases, the EED can indicate a difference between a loss associated with the output 412 from the compute path 410 and a loss associated with the output 425 from the compute path 415. In other examples, the EED can indicate a difference in a particular metric between the output 412 from the compute path 410 and the output 425 from the compute path 415, such as an error metric, an output quality metric, an accuracy or performance metric, a safety metric, a compute cost, or any other metric.

In some cases, the switch 404 can select the compute path 410 if an EED associated with the compute path 410 is above a threshold, and the compute path 414 if the EED is below a threshold. An EED above a threshold can indicate a certain amount of error reduction is achieved when implementing the compute path 410 rather than the compute path 415, and an EED below a threshold can indicate that a certain amount of error reduction is not achieved (e.g., less than the certain amount of error reduction is achieved) when implementing the compute path 410 rather than the compute path 415. Thus, the EED threshold can define and/or allow the switch 404 to achieve a certain balance between quality and performance (e.g., latency, safety, speed, compute, etc.). For example, if the EED is above a threshold, the switch 404 can select the compute path 410 to obtain a higher quality/accuracy output (as opposed to the output from the compute path 415) even though the compute path 410 has a higher latency, a higher compute footprint/cost, and/or a lower speed than the compute path 415. On the other hand, if the EED is below a threshold, the switch 404 can select the compute path 415, which involves a trade-off between the performance (e.g., latency, speed, etc.) benefits of the compute path 415 (e.g., versus the compute path 410) and the quality/accuracy benefits of the compute path 410 (and thus the quality/accuracy drawback of the compute path 415).

In other words, the EED threshold can represent a desired trade-off between the higher quality/accuracy obtained from the compute path 410, and the lower latency, compute footprint/burden, and/or safety metrics obtained from the compute path 415. In some cases, the EED threshold can be set based on a particular trade-off desired between the higher quality/accuracy obtained from the compute path 410 and the lower latency, compute footprint/burden, and/or safety metrics obtained from the compute path 415. For example, a particular EED threshold can indicate a certain improvement in output quality/accuracy is achieved when the compute path 410 is implemented rather than the compute path 415. Thus, if that output quality/accuracy is desired over the performance improvements (e.g., latency, speed, compute burden, etc.) associated with the compute path 415, the EED threshold associated with that output quality/accuracy can be implemented to trigger the switch 404 to select the compute path 410 instead of the compute path 415 when the EED threshold is satisfied.

If, on the other hand, the performance improvements (e.g., latency, speed, compute burden, etc.) associated with the compute path 415 are desired over output quality/accuracy improvements up to a certain amount, the EED threshold can be set such that the switch 404 will select the compute path 415 (over the compute path 410) to obtain the performance improvements associated with the compute path 415 over the output quality/accuracy improvements up to the certain amount. In this example, if the EED associated with the compute path 410 exceeds the EED threshold (e.g., indicating that the output quality/accuracy improvements associated with the compute path 410 meet or exceed the certain amount), the switch 404 can use the EED to select the compute path 410 over the compute path 415, thereby favoring the output quality/accuracy improvements of the compute path 410 over the performance improvements (e.g., latency, speed, compute footprint/burden, etc.) of the compute path 415.

Thus, the EED threshold can be used to achieve a desired balance between output quality/accuracy and compute path performance (e.g., latency, speed, compute footprint/burden, safety metrics, etc.) when selecting between the compute path 410 and the compute path 415. Accordingly, in some examples, the EED threshold can be optimized/tuned based on a desired trade-off between accuracy/quality, latency, safety, speed, compute burden/cost, and/or any other factors/metrics. In some cases, the EED threshold can be learned by the switch 404 (and/or a neural network model such as the neural network 400 or a separate neural network) based on a determined EED estimated by comparing the output 412 from the compute path 410 and the output 425 from the compute path 415 (e.g., by comparing a loss or error difference between the output 412 from the compute path 410 and the output 425 from the compute path 415) and a particular trade-off desired between accuracy/quality, latency, speed, compute burden/costs, safety metrics, and/or any other factors.

The switch 404 can use the EED threshold to determine (e.g., select) whether to use the compute path 410 or the compute path 415 to process an output from the neural network portion 402. For example, if the EED associated with the compute path 410 meets or exceeds the EED threshold, the switch 404 can select the compute path 410 as the path used to process an output(s) from the neural network portion 402, and if the EED associated with the compute path 410 does not meet or exceed the EED threshold, the switch 404 can instead select the compute path 415 as the path used to process an output(s) from the neural network portion 402.

In some cases, the EED associated with the compute path 410 can be determined by comparing a metric (e.g., a loss or error, a safety metric, a quality metric, an accuracy metric, etc.) associated with the compute path 410 and a metric associated with the compute path 415. For example, the EED associated with the compute path 410 can be determined by comparing a loss associated with outputs from the compute path 410 and a loss associated with outputs from the compute path 415. In some cases, the EED can represent the difference between the loss associated with outputs from the compute path 410 and the loss associated with outputs from the compute path 415.

In some cases, the EED can be calculated using a neural network model that is trained using input data used by the compute path 410 and the compute path 415. For example, the EED can be calculated by a neural network model that is trained to determine a difference between a metric (e.g., a loss, etc.) estimated for outputs from the compute path 410 and the metric estimated for outputs from the compute path 415. In some aspects, the EED can be calculated in parallel to processing performed via the compute path 415. For example, as previously explained, the compute path 415 can achieve a lower latency, higher speed, and/or reduction in compute relative to the compute path 410. Thus, when the compute path 415 is implemented, which would consume less compute than the compute path 410, the EED can be calculated in parallel to processing data via the compute path 415.

As noted above, the switch 404 can select between the compute path 410 and the compute path 415 based on an EED associated with the compute path 410 and an EED threshold. For example, if the EED indicates that processing the data from the neural network portion 402 using the compute path 410 (as opposed to the compute path 415) will yield a small error reduction in the output (e.g., the increase in accuracy when using the compute path 410 relative to when using the compute path 415 is below a threshold and/or the error reduction in the output from the compute path 410 relative to the output from the compute path 415 is below a threshold), the switch 404 can determine to use the compute path 415 as any decrease in accuracy and/or increase in error resulting from using the compute path 415 instead of the compute path 410 is outweighed by the benefits in speed, latency, and compute footprint/cost from using the compute path 415 instead of the compute path 410.

On the other hand, if the EED indicates that processing the data from the neural network portion 402 using the compute path 410 (as opposed to the compute path 415) will yield a larger error reduction in the output (e.g., the increase in accuracy when using the compute path 410 as opposed to the compute path 415 is above a threshold and/or the error reduction in the output from the compute path 410 relative to the output from the compute path 415 is above a threshold), the switch 404 can determine to use the compute path 410 instead of the compute path 415 as any benefits in speed, latency, compute footprint/cost, etc., of using the compute path 415 is outweighed by the increase in accuracy and/or safety when using the compute path 410. In some cases, the compute path 410 and the compute path 415 can be trained using scene data. In some cases, the neural network 400 can learn the compute path 410 and the compute path 415 (e.g., can create or discover the compute path 410 and the compute path 415 and/or can learn to use the compute path 410 and/or the compute path 415) based on scene data processed by the neural network 400. For example, the neural network 400 can learn to implement the compute path 410 or the compute path 415 to process certain data, scenes, and/or scene features.

In some aspects, the neural network 400 can continue to learn as it processes more scene data. Through the continued learning, the neural network 400 can modify the compute path 410 and/or the compute path 415. For example, the neural network 400 can reconfigure the compute path 410 or the compute path 415 to include or exclude certain neural network layers, neurons/nodes, functions, etc., based on the continued learning. In some examples, the switch 404 can be trained to learn to select the compute path 410 or the compute path 415 for certain data and/or scenes. For example, the switch 404 can determine the metrics (e.g., safety, latency, speed, compute, accuracy, etc.) achieved by the compute path 410 and the compute path 415 for certain data and/or scenes, and can learn to select the compute path 410 or the compute path 415 for such data and/or scenes based on the metrics associated with the compute path 410 and the compute path 415. The switch 404 can learn a desired or suggested trade-off or balance between accuracy, safety, latency, speed, and compute, and use the desired or suggested trade-off or balance to determine whether to select the compute path 410 or the compute path 415 when processing specific data from the neural network portion 402 and/or an associated scene(s).

In some cases, the switch 404 can additionally or alternatively cluster embeddings (e.g., scene features) from an output of the neural network portion 402 and use the clustering of embeddings to select between the compute path 410 and the compute path 415. For example, in some cases, the compute path 410 can be trained using a first clustering(s) of embeddings from the neural network portion 402 and the compute path 415 can be trained using a second clustering(s) of embeddings from the neural network portion 402. In this example, if the output from the neural network portion 402 is within the first clustering(s) and/or has a threshold similarity to features in the first clustering(s), the switch 404 can select the compute path 410 to process the output from the neural network portion 402, as the compute path 410 is better suited and/or trained to process features from the first clustering(s). If the output from the neural network portion 402 is instead within the second clustering(s) and/or has a threshold similarity to features in the second clustering(s), the switch 404 can select the compute path 415 to process the output from the neural network portion 402, as the compute path 415 may be better suited and/or trained to process features from the second clustering(s).

If the switch 404 selects the compute path 410 as previously explained, the switch 404 can activate the compute path 410 to process an output(s) from the neural network portion 402 and/or can steer the output(s) from the neural network portion 402 to the compute path 410. Here the compute path 410 can process the output(s) from the neural network portion 402 and generate an output 412. Moreover, when the switch 404 selects the compute path 410 to process certain data, the switch 404 can deactivate the compute path 415 to prevent the compute path 415 from using compute resources when the compute path 415 is not in use. On the other hand, if the switch 404 selects the compute path 415 as previously explained, the switch 404 can activate the compute path 415 to process an output(s) from the neural network portion 402 and/or can steer the output(s) from the neural network portion 402 to the compute path 415. The compute path 415 can process the output(s) from the neural network portion 402 and generate an output 425. The switch 404 can also deactivate the compute path 410 when it selects the compute path 415 for certain data and/or a certain load, to prevent the compute path 410 from using compute resources when not in use.

In some cases, the neural network 400 can intelligently/dynamically adjust an EED threshold used to select between the compute path 410 and the compute path 415. For example, a neural network model (e.g., neural network 400 or a different neural network) can analyze outputs from the compute path 410 and the compute path 415 to determine characteristics of such outputs such as, for example, latency, speed, compute usage/costs, safety metrics, quality/accuracy metrics, etc. The neural network model can use the characteristics of the outputs from the compute path 410 and the compute path 415 to tune/optimize the EED threshold to achieve any desired trade-offs between accuracy/quality, latency, speed, compute, safety, etc. In some cases, the characteristics of the outputs from the compute path 410 and the compute path 415 can change over time. For example, the characteristics of the outputs from the compute path 410 and the compute path 415 can change as the compute path 410 and/or the compute path 415 are further trained and/or turned. In such cases, the neural network model can adjust the EED threshold based on the changed characteristics of the outputs from the compute path 410 and the compute path 415.

In some aspects, the switch 404 (and/or the neural network 400) can learn when to select the compute path 410 to process data from the neural network portion 402 or when to instead use the compute path 415. For example, the switch 404 and/or the neural network 400 can learn to use the compute path 410 when processing data corresponding to a more complex scene (e.g., a scene having a threshold complexity or above a threshold complexity) and use the compute path 415 when processing data corresponding to a less complex scene. Since the compute path 410 is larger, more robust, and/or more accurate than the compute path 415, the compute path 410 may be better suited for more complex scenes as it can provide more accurate results than the compute path 415 when processing the more complex scene. On the other hand, when processing a less complex scene, the compute path 415, which is smaller and/or less robust than the compute path 410, may be more suitable than the compute path 410 to process the less complex scene as the compute path 415 can process the less complex scene faster, with a lower latency, a lower compute footprint/cost, a sufficient accuracy, and without a threshold reduction in safety metrics/results.

In some examples, as the switch 404 and/or the neural network 400 process more data, it/they can learn how determine whether a scene depicted in the data to be processed is sufficiently complex to trigger using the compute path 410 instead of the compute path 415, or whether the complexity of the scene is sufficiently low that the compute path 415 can process the scene (e.g., the data associated with the scene) without a threshold reduction or trade-off in accuracy and/or safety. A scene's complexity can depend on various factors such as, for example and without limitation, the number of people, animals, and/or objects in the scene; the type of activity and/or the amount of activity taking place in the scene; the size of objects in the scene; the density of objects in the scene; the geometry of one or more scene elements (e.g., roads/streets, curbs, buildings, traffic signs, turns, etc.); the nature and/or intention of target (e.g., if the intention of a target is more difficult for the neural network to determine); and/or any other factors.

For example, the switch 404 and/or the neural network 400 may learn that a scene with a threshold amount of objects, people, vehicles, and/or animals should be treated as a complex scene that should be processed by the compute path 410. As another example, if a scene has a threshold amount of activity (e.g., from pedestrians, vehicles, animals, bicycles, motorcycles, moving objects, etc.), the switch 404 and/or the neural network 400 may determine that the scene should be treated as a complex scene that should be processed by the compute path 410. On the other hand, if the scene has less than a threshold amount of activity or actors (e.g., pedestrians, vehicles, animals, etc.) and is easier to process, the switch 404 and/or the neural network 400 may determine or learn that such a scene can be processed by the compute path 415 in order to increase the processing speed, decrease the processing latency, reduce the compute used to process the scene, etc., without a threshold reduction in accuracy and/or safety.

The examples above are merely illustrative examples provided for clarity and explanation purposes. As previously noted, the switch 404 and/or the neural network 400 can learn to determine which scenes it can process using the compute path 415 to increase the processing speed, reduce the processing latency, and reduce the compute used to process the scene without the output form the compute path 415 experiencing a threshold reduction in accuracy and/or safety, and which scenes it should process using the compute path 410 to avoid a threshold reduction in accuracy and/or safety. For example, the switch 404 and/or the neural network 400 can learn from processing various scenes (e.g., processing scene data) what attributes in a scene, what scene configuration, what scene densities, and/or what characteristics of a scene render the scene sufficiently complex that the scene (e.g., the scene data) should be processed using the compute path 410, and what scene attributes, scene configurations, scene densities, and/or scene characteristics render the scene sufficiently low in complexity to allow the compute path 415 to process the scene without a threshold reduction in an accuracy and/or safety associated with the processing output.

The number of compute paths shown in FIG. 4 is merely one illustrative example provided for explanation purposes. One of ordinary skill in the art will recognize in view of this disclosure that, in other examples, the systems and techniques described herein can learn and implement more than two compute paths. For example, in some cases, the neural network 400 can include the two compute paths shown in FIG. 4 and one or more additional compute paths. Moreover, the number of elements in each compute path shown in FIG. 4 is merely an illustrative example provided for explanation purposes. One of ordinary skill in the art will recognize in view of this disclosure that, in other examples, a compute path can include more or less elements than shown in FIG. 4.

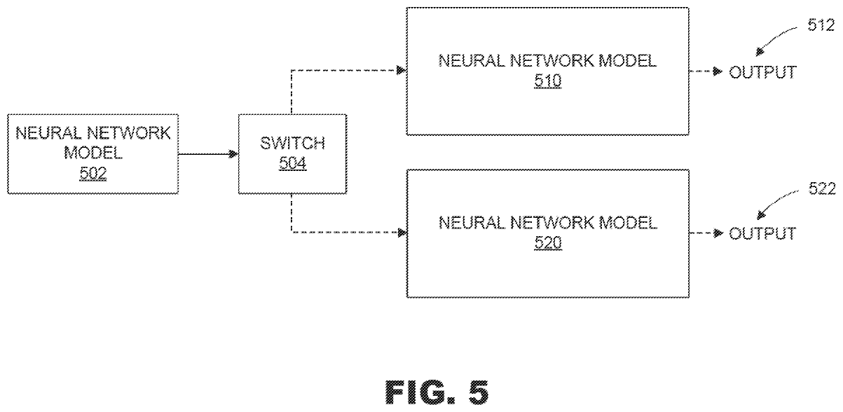

FIG. 5 is a diagram illustrating example neural network models used to implement different compute paths in accordance with some examples of the present disclosure. As shown, a switch 504 can use an output from a neural network model 502 to intelligently determine (e.g., select) whether to use neural network model 510 or neural network model 520 to process data (e.g., an output(s)) from the neural network model 502. The neural network model 502 can represent a neural network, a branch of a neural network, or one or more portions of a neural network such as, for example, one or more neural network layers, neurons/nodes, functions, parameters, and/or any other portion of a neural network.

The neural network model 510 and the neural network model 520 can process the same (or similar) data and/or perform a same (or similar) operation(s). For example, the neural network model 510 and the neural network model 520 can be configured and/or trained to process the same or similar data and/or perform a same or similar operation(s). In some cases, the neural network model 502, the neural network model 510, and/or the neural network model 520 can be separate neural network models. In other cases, the neural network model 502, the neural network model 510, and/or the neural network model 520 can be part of a same neural network model. For example, the neural network model 502, the neural network model 510, and/or the neural network model 520 can represent separate neural network branches or models within a larger neural network model. In yet other cases, the neural network model 502, the neural network model 510, and/or the neural network model 520 can be separate neural network portions of a neural network model such as, for example, separate neural network layers, neurons/nodes, functions, etc.

In FIG. 5, the neural network model 510 is a larger neural network model, neural network model branch, or neural network model portion than the neural network model 520. For example, the neural network model 520 can be a smaller version of the neural network model 510. To illustrate, the neural network model 520 can include less neural network layers, neurons/nodes, functions, and/or other neural network elements than the neural network model 510. In some cases, the neural network model 520 can be generated by downsizing a copy of the neural network model 510 (or a portion of the neural network model 510) to yield a smaller version of the neural network model 510 (or a portion thereof). The copy of the neural network model 510 can be downsized by pruning at least a portion of the neural network model 510 (e.g., pruning one or more layers, neurons/nodes, functions, and/or any other neural network elements), quantizing (or otherwise compressing) the neural network model 510, reducing a size of blocks/layers of the neural network model 510, and/or any other downsizing techniques. To illustrate, the downsized version of the neural network model 510 (e.g., neural network model 520) can be created by pruning a portion(s) of the neural network model 510, such as pruning one or more layers, neurons, and/or neural network elements; quantizing or otherwise compressing the neural network model 510; and/or reducing a size of blocks/layers of the neural network model 510.

In addition to being larger than the neural network model 520 (and thus having a larger compute footprint/burden), the neural network model 510 can generate outputs that have a higher quality/accuracy than outputs generated by the neural network model 520. In some cases, the outputs from the neural network model 510 can have a higher safety metric(s) than the neural network model 520. In other words, when implemented to perform one or more operations used by an AV to operate, the neural network model 510 can generate safer and/or more reliable outputs than the neural network model 520. On the other hand, the neural network model 520 can have a smaller compute footprint/burden than the neural network model 510, can process data and/or generate outputs at faster speed than the neural network model 510, can have a smaller/lower latency in generating outputs and/or processing data than the neural network model 510, and/or can have one or more other differences in performance metrics and/or other characteristics. Accordingly, when selecting the neural network model 510 over the neural network model 520 and vice versa, there is a trade-off between a number of metrics/characteristics such as, for example, a trade-off between safety metrics, latency metrics, compute metrics, performance metrics, and/or any other metrics.

To illustrate, selecting the neural network model 510 over the neural network model 520 can include a trade-off between better latency and speed metrics (e.g., lower latency, higher speed, etc.) associated with the neural network model 520 (e.g., relative to the latency and speed metrics associated with the neural network model 510) and a lower compute footprint/cost associated with the neural network model 520 (e.g., relative to the compute footprint/cost associated with the neural network model 510), and better safety metrics (e.g., safer AV outputs/operations) and higher output quality/accuracy associated with the neural network model 510 (e.g., relative to the safety metrics and an output quality/accuracy associated with the neural network model 520). Similarly, selecting the neural network model 520 over the neural network model 510 can include a trade-off between better safety metrics (e.g., safer AV outputs/operations) and higher output quality/accuracy associated with the neural network model 510 (e.g., relative to safety metrics and output quality/accuracy associated with the neural network model 520), and better latency and speed metrics (e.g., lower latency, higher speed, etc.) associated with the neural network model 520 (e.g., relative to the neural network model 510) and a lower compute footprint/cost associated with the neural network model 520 (e.g., relative to the compute footprint/cost associated with the neural network model 510).

In some cases, the neural network model 502, the neural network model 510, and/or the neural network model 520 can be part of a same neural network model. For example, the neural network model 502, the neural network model 510, and/or the neural network model 520 can represent branches of a neural network or sub-networks of a neural network. In other examples, the neural network model 502, the neural network model 510, and/or the neural network model 520 can represent different or separate neural network models. In some cases, the neural network model 502, the neural network model 510, and/or the neural network model 520 can at least partly overlap. For example, the neural network model 502, the neural network model 510, and/or the neural network model 520 can share or include a same neural network portion(s) such as, for example, a same layer or set of layers, a same neuron or set of neurons, a same neural network parameter or set of neural network parameters, etc.

The switch 504 can be the same as the switch 404 shown in FIG. 4 or different than the switch 404 shown in FIG. 4. In some examples, the switch 504 can be part of the neural network model 502. In other examples, the switch 504 can be part of a different/separate neural network model than the neural network model 502, or can be or include a separate and/or a standalone software algorithm, code, application, service, and/or script. The switch 504 can determine whether to process data from the neural network model 502 through the neural network model 510 or the neural network model 520 based on one or more factors such as, for example, a processing latency and/or speed, a compute load/burden associated with the neural network model 510 and the neural network model 520, a quality and/or accuracy of an output(s) of the neural network model 510 and an output(s) of the neural network model 520, and/or one or more other factors.

Moreover, the switch 504 can use an output(s) of the neural network model 502 to determine whether to process that output(s) using the neural network model 510 or the neural network model 520. In some cases, the switch 504 can use an EED associated with the neural network model 510 and a configured EED threshold as previously explained, to select the neural network model 510 or the neural network model 520 as the compute path to use to process data from the neural network 502. For example, when determining whether to use the neural network model 510 or the neural network model 520 to process data (e.g., outputs) from the neural network model 502, the switch 504 can determine whether an EED of the neural network model 510 matches or exceeds an EED threshold. If the EED of the neural network model 510 matches or exceeds the EED threshold, the switch 504 can select the neural network model 510 to process the data from the neural network model 502. Alternatively, if the EED of the neural network model 510 does not match or exceed the EED threshold, the switch 504 can select the neural network model 520 to process the data from the neural network model 502.

The EED can indicate an error reduction (and/or quality improvement) in an output 512 of the neural network model 510 relative to (and/or compared to) an output 522 of the neural network model 520. In other words, the EED can indicate how much of an error reduction is achieved when implementing the neural network model 510 (which is larger and/or more robust than the neural network model 520) to process an output from the neural network model 502 and/or perform an operation(s) using data from the neural network model 502, as opposed to when implementing the neural network model 520. For example, in some cases, the EED can indicate a difference between a loss associated with the output 512 from the neural network model 510 and a loss associated with the output 522 from the neural network model 520. In other examples, the EED can indicate a difference in a particular metric between the output 512 from the neural network model 510 and the output 522 from the neural network model 520, such as an output quality metric, an accuracy or performance metric, a safety metric, a compute cost, or any other metric.

In some cases, the switch 504 can select the neural network model 510 to process data from the neural network model 502 if an EED associated with the neural network model 510 is above a threshold, and select the neural network model 520 if the EED is below a threshold. An EED above a threshold can indicate a certain amount of error reduction is achieved when implementing the neural network model 510 rather than the neural network model 520, and an EED below a threshold can indicate that a certain amount of error reduction is not achieved (and/or less than a certain amount of error reduction is achieved) when implementing the neural network model 510 rather than the neural network model 520. Thus, the EED threshold can define and/or allow the switch 504 to achieve a certain balance between quality and performance (e.g., latency, safety, speed, compute, etc.). For example, if the EED is above a threshold, the switch 504 can select the neural network model 510 to obtain a higher quality/accuracy output (as opposed to the output from the neural network model 520) even though the neural network model 510 has a higher latency, a higher compute footprint/cost, and/or a lower speed than the neural network model 520. On the other hand, if the EED is below a threshold, the switch 504 can select the neural network model 520, which involves a trade-off between the performance (e.g., latency, speed, etc.) benefits of the neural network model 520 (e.g., versus the neural network model 510) and the quality/accuracy benefits of the neural network model 510 (and thus the quality/accuracy drawback of the neural network model 520).

In other words, the EED threshold can represent a desired trade-off between the higher quality/accuracy and safety obtained from the neural network model 510, and the lower latency, compute footprint/burden, and/or safety metrics obtained from the neural network model 520. In some cases, the EED threshold can be set based on a particular trade-off desired between the higher quality/accuracy and/or safety obtained from the neural network model 510 and the lower latency, compute footprint/burden, and/or safety metrics obtained from the neural network model 520. For example, a particular EED threshold can indicate a certain improvement in output quality/accuracy is achieved when the neural network model 510 is implemented rather than the neural network model 520. Thus, if that output quality/accuracy is desired over the performance improvements (e.g., latency, speed, compute footprint/costs, etc.) associated with the neural network model 520, the EED threshold associated with that output quality/accuracy can be implemented to trigger the switch 504 to select the neural network model 510 instead of the neural network model 520 when the EED threshold is satisfied.

If, on the other hand, the performance improvements (e.g., latency, speed, compute footprint/costs, etc.) associated with the neural network model 520 are desired over output quality/accuracy improvements up to a certain amount (e.g., up to the quality/accuracy improvements achieved using the neural network model 510), the EED threshold can be set such that the switch 504 will select the neural network model 520 (over the neural network model 510) to obtain the performance improvements associated with the neural network model 520 over the output quality/accuracy improvements up to the certain amount (e.g., over the quality/accuracy improvements of the neural network model 510). In this example, if the EED associated with the neural network model 510 exceeds the EED threshold (e.g., indicating that the output quality/accuracy improvements associated with the neural network model 510 meet or exceed the certain amount), the switch 504 can use the EED to select the neural network model 510 over the neural network model 5120, thereby favoring the output quality/accuracy improvements of the neural network model 510 over the performance improvements (e.g., latency, speed, compute footprint/burden, etc.) of the neural network model 520.

Thus, the EED threshold can be used to achieve a desired balance between output quality/accuracy and compute path performance (e.g., latency, speed, compute footprint/costs, safety metrics, etc.) when selecting between the neural network model 510 and the neural network model 520. Accordingly, in some examples, the EED threshold can be optimized/tuned based on a desired trade-off between accuracy/quality, latency, safety, speed, compute footprint/costs, and/or any other factors/metrics. In some cases, the EED threshold can be learned by the switch 504 (and/or a neural network model such as the neural network model 502 or a separate neural network model) based on a determined EED estimated by comparing the output 512 from the neural network model 510 and the output 522 from the neural network model 520 (e.g., by comparing a loss or error difference between the output 512 from the neural network model 510 and the output 522 from the neural network model 520) and a particular trade-off desired between accuracy/quality, latency, speed, compute footprint/costs, safety metrics, and/or any other factors.

In some cases, the switch 504, the neural network model 502, or a separate neural network model (not shown) can determine or learn that data and/or outputs from the neural network model 502 can be processed via the neural network model 510 and/or the neural network model 520, and/or that the AV 102 can use the neural network model 510 or the neural network model 520 to perform a certain operation(s) implemented using data from the neural network model 502. Thus, the AV 102 can determine that either the neural network model 510 or the neural network model 520 can be used as the compute path for data from the neural network model 502. In some examples, when the switch 504 selects the neural network model 510 to process data from the neural network model 502, the switch 504 can deactivate the neural network model 520 (and/or portions thereof) to prevent the neural network model 520 from utilizing compute resources while not in use. Similarly, when the switch 504 selects the neural network model 520 to process data from the neural network model 502, the switch 504 can deactivate the neural network model 510 (and/or portions thereof) to prevent the neural network model 510 from utilizing compute resources while not in use.

As previously noted, the switch 504 can use an EED threshold to determine (e.g., select) whether to use the neural network model 510 or the neural network model 520 to process an output from the neural network model 502. In some cases, the EED associated with the neural network model 510 can be determined by comparing a metric (e.g., a loss or error, a safety metric, a quality metric, an accuracy metric, etc.) associated with the neural network model 510 and a metric associated with the neural network model 520. For example, the EED associated with the neural network model 510 can be determined by comparing a loss associated with outputs from the neural network model 510 and a loss associated with outputs from the neural network model 520. In some cases, the EED can represent the difference between the loss associated with outputs from the neural network model 510 and the loss associated with outputs from the neural network model 520.

In some cases, the EED can be calculated using a neural network model that is trained using input data used by the neural network model 510 and/or the neural network model 520. For example, the EED can be calculated by a neural network model that is trained to determine a difference between a metric (e.g., a loss, etc.) estimated for outputs from the neural network model 510 and the metric estimated for outputs from the neural network model 520. In some aspects, the EED can be calculated in parallel to processing performed via the neural network model 520. For example, as previously explained, the neural network model 520 can achieve a lower latency, higher speed, and/or reduction in compute relative to the neural network model 510. Thus, when the neural network model 520 is implemented (e.g., selected), which would consume less compute than the neural network model 510, the EED can be calculated in parallel to processing data via the neural network model 520.

In some cases, the neural network model 510 can be trained using a cluster of scene features determined and/or processed by the neural network model 502. For example, the neural network model 510 can be trained using a cluster(s) of scene features associated with an output of the neural network model 502, and the neural network model 520 can be trained using a smaller set of clustered scene features associated with an output of the neural network model 502, such as clustered scene features having a higher similarity than at least some of the clustered scene features used to train the neural network model 510 and/or having a threshold similarity.

As previously noted, the switch 504 can use an EED to determine whether to select the neural network model 510 or the neural network model 520 to process certain data (e.g., an output from the neural network model 502) and/or perform a certain task. In other cases, the switch 504 can (additionally or alternatively) cluster embeddings (e.g., scene features) from an output of the neural network model 502 and use the clustering of embeddings to select between the neural network model 510 and the neural network model 520. For example, in some cases, the neural network model 510 can be trained using a first clustering(s) of embeddings from the neural network model 502 and the neural network model 510 can be trained using a second clustering(s) of embeddings from the neural network model 502. In this example, if the output from the neural network model 502 is within the first clustering(s) and/or has a threshold similarity to features in the first clustering(s), the switch 504 can select the neural network model 510 to process the output from the neural network model 502, as the neural network model 510 is better suited and/or trained to process features from the first clustering(s). If the output from the neural network model 502 is instead within the second clustering(s) and/or has a threshold similarity to features in the second clustering(s), the switch 504 can select the 5 neural network model 520 to process the output from the neural network model 502, as the neural network model 520 may be better suited and/or trained to process features from the second clustering(s).

FIG. 6 is a diagram illustrating an example compute path with an early exit branch in accordance with some examples of the present disclosure. In this example, the neural network 600 includes a compute path 620 that it uses to process data such as, for example scene data obtained from sensors on the AV 102. The compute path 620 includes layers 602 to 610. In other examples, the compute path 620 can include more or less layers than the layers shown in FIG. 6.

The neural network 600 can learn an alternate path to implement to process data in certain scenarios. The alternate path can include a portion of the compute path 620 and an early exit 622 from the compute path 620 to an output layer(s) 612. The neural network 600 can implement the alternate path with the early exit 622 to reduce a processing latency, increase a processing speed, and reduce a compute footprint/cost. The neural network 600 can learn when to implement the alternate path with the early exit 622 without causing a threshold reduction in the output's accuracy and/or safety. In some examples, the neural network 600 can select between the compute path 620 and the alternate path with the early exit 622 based on a desired trade-off or balance (or range of trade-offs or balances) between accuracy, safety, latency, speed, and compute.

For example, if using the alternate path with the early exit 622 to process certain scene data will cause a threshold reduction in the accuracy and/or safety of the output, the neural network 600 can select the compute path 620 to process the scene data. On the other hand, if using the alternate path with the early exit 622 to process certain scene data will not cause a threshold reduction in the accuracy and/or safety of the output, the neural network 600 can select the alternate path with the early exit 622 to process the scene data in order to decrease the processing latency, increase the processing speed, and decrease the compute footprint/cost without experiencing a threshold reduction in accuracy and/or safety. In some cases, the neural network 600 can learn a condition(s) that it can use to determine whether to implement a longer compute path (e.g., compute path 620) or a shorter compute path (e.g., the alternate path with the early exit 622).

In some cases, the neural network 600 can decide whether to implement the early exit 622 or not based on a conditional signal. The conditional signal can include, for example and without limitation, an EED, a trade-off in metrics (e.g., safety, accuracy, latency, speed, compute, etc.), scene attributes (e.g., types of objects in the scene, number of objects in the scene, activities in the scene, lighting in the scene, weather conditions in the scene, geometry of the scene, traffic conditions in the scene, etc.), scene complexity, and/or any other conditions. In some cases, the early exit decision can be temporal based on where an AV preemptively switches between early exit and back based on trends associated with an early exit conditional signal.

While FIG. 6 shows one alternate path with an early exit 622, other examples can include more alternate paths and/or different early exits than shown in FIG. 6. In some cases, the neural network 600 can learn multiple, alternate paths. In some examples, the neural network 600 can learn compute paths and alternate paths such that a certain metric (e.g., latency, speed, etc.) remains the same no matter which combination of path options is taken/implemented.

Different stacks of the AV's software (e.g., the robot operating system implemented by an AV) can implement neural network models. Each of the neural network models can be trained to implement multiple compute paths. In some examples, a smaller neural network model can be trained to decide which compute path in a neural network model to implement in a specific scenario (e.g., for a specific scene and/or associated data).

In some cases, the neural network 600 can branch a compute into multiple, data-dependent paths that have a same metric such as, for example, a same latency, a same speed, etc. For example, the neural network 600 can branch a compute into multiple, data-dependent paths that have a same latency. This can reduce the variation in latency associated with the various paths, while also reducing the overall latency of the system.

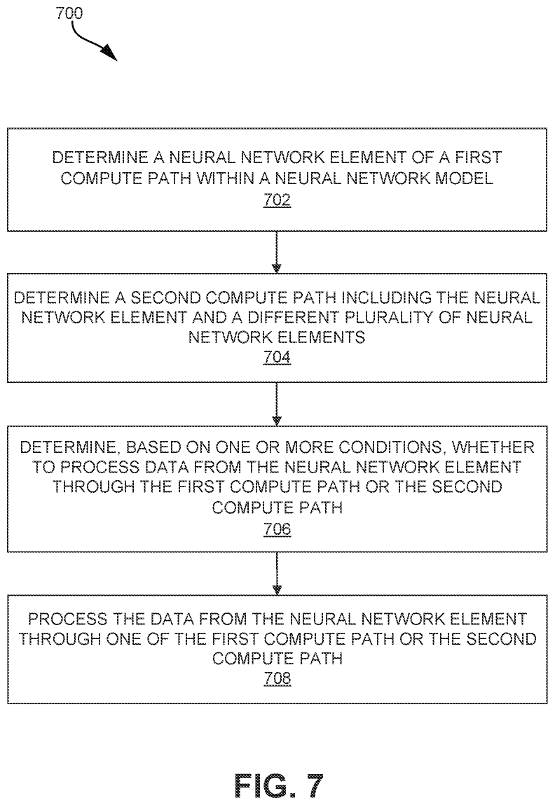

FIG. 7 is a flowchart illustrating an example process 700 for learning and implementing deep learning compute paths. At block 702, the process 700 can include determining a neural network element of a first compute path (e.g., compute path 410 or compute path 620) within a neural network model (e.g., neural network 400, neural network 600). In some examples, the first compute path can include a plurality of neural network elements including the neural network element. The plurality of neural network elements can include, for example and without limitation, neural network layers, neural network nodes, neural network functions, and/or any other neural network components. In some examples, the neural network element can include a neural network layer and/or a neural network node.

At block 704, the process 700 can include determining a second compute path (e.g., compute path 415) that includes the neural network element and a different plurality of neural network elements. The second compute path can have a smaller size than the first compute path, a lower latency than the first compute path, and/or a smaller compute cost than the second compute path. In some examples, the different plurality of neural network elements can include a different set of neural network layers, nodes, functions, and/or any other neural network components.

In some cases, the first compute path can be larger than the second compute path. For example, the first compute path may include a larger neural network model or neural network model branch than the second compute path. As another example, the first compute path may include more neural network layers, nodes, functions, and/or any other neural network components than the second compute path.

In some cases, determining the second compute path can include copying or duplicating the first compute path to yield a duplicated compute path; and downsizing the duplicated compute path to yield the second compute path. In some examples, downsizing the duplicated compute path can include compressing or quantizing the duplicated compute path, pruning one or more portions (e.g., one or more layers, one or more nodes, one or more functions, etc.) of the duplicated compute path, and/or reducing a size of one or more neural network layers of the duplicated compute path.

At block 706, the process 700 can include determining, based on one or more conditions, whether to process data from the neural network element through the first compute path or the second compute path. For example, the local computing device 110 of the AV 102 can determine whether to process an output from the neural network element through the first compute path or the second compute path. The local computing device 110 can select either the first compute path or the second compute path based on a desired trade-off or balance between output accuracy, safety metrics, latency, speed, and/or compute costs.

For example, the local computing device 110 may determine safety metrics indicating a safety of an output and/or an operation generated using the first compute path and safety metrics indicating a safety of an output and/or an operation generated using the second compute path. In addition, the local computing device 110 may determine a processing latency associated with the first compute path and a processing latency associated with the second compute path, an accuracy of an output(s) from the first compute path and an accuracy of an output(s) from the second compute path, a processing speed associated with the first compute path and a processing speed associated with the second compute path, and/or a compute cost associated with the first compute path and a compute cost associated with the second compute path. The local computing device 110 can compare the safety metrics, latencies, speeds, accuracies, and/or compute costs associated with the first compute path and the second compute path and select either the first compute path or the second compute path based on a desired trade-off or balance between the safety metrics, latencies, speeds, accuracies, and/or compute costs.

In some cases, the local computing device 110 can determine whether a difference between the safety metrics associated with the first and second compute paths and a difference between the accuracies of outputs from the first and second compute paths exceed (or match) one or more thresholds (e.g., exceed a first threshold associated with the safety metrics and/or a second threshold associated with the output accuracies). If the difference between the safety metrics associated with the first and second compute paths and/or the difference between the accuracies of outputs from the first and second compute paths exceed the one or more thresholds, the local computing device 110 can select the first compute path to process the data from the neural network element. Here, the local computing device 110 is selecting the increased safety and/or accuracy of the outputs from the first compute path relative to the safety and/or accuracy of the outputs from the second compute path, over any benefits in latency, speed, and/or compute costs achieved by using the second compute path instead of the first compute path.

On the other hand, if the difference between the safety metrics associated with the first and second compute paths and/or the difference between the accuracies of outputs from the first and second compute paths do not exceed (or match) the one or more thresholds, the local computing device 110 can select the second compute path to process the data from the neural network element. Here, the local computing device 110 is selecting the benefits in latency, speed, and/or compute costs achieved by using the second compute path instead of the first compute path over the increased safety and/or accuracy of the outputs from the first compute path relative to the safety and/or accuracy of the outputs from the second compute path. For example, the local computing device 110 may determine that the safety and/or accuracy of outputs from the second compute path are acceptable, that the benefits in safety and/or accuracy in using the first compute path instead of the second compute path are sufficiently small that they are outweighed by the benefits in latency, speed, and/or compute costs gained by using the second compute path instead of the first compute path.

In some examples, the one or more conditions can include a difference in an accuracy of a first output from the first compute path and a second output from the second compute path. In some aspects, the process 700 can include determining the difference in the accuracy of the first output from the first compute path and the second output from the second compute path; and based on a determination that the difference in the accuracy is above a threshold, selecting to process the data from the neural network element via the first compute path. In other aspects, the process 700 can include determining the difference in the accuracy of the first output from the first compute path and the second output from the second compute path; and based on a determination that the difference in the accuracy is below a threshold, selecting to process the data from the neural network element via the second compute path.

The first compute path and the second compute path can be associated with different processing latencies, different compute costs, different safety metrics, and/or different output accuracies. In some implementations, the one or more conditions can include a desired balance between at least two of a processing latency, a compute cost, a safety metric, and/or an output accuracy

At block 708, the process 700 can include processing the data from the neural network element through one of the first compute path or the second compute path. For example, if at block 706 the local computing device 110 of the AV 102 determines to process the data from the neural network element through the first compute path, at block 708 the local computing device 110 can process the data from the neural network element through the first compute path, and if instead the local computing device 110 determines to process the data from the neural network element through the second compute path, the local computing device 110 accordingly process the data from the neural network element through the second compute path.

In some cases, the first compute path can include a first portion of the neural network model or a first branch of the neural network model, and the second compute path can include a second portion of the neural network model or a second branch of the neural network model. In other cases, the first compute path can include the neural network model and the second compute path can include an additional neural network model that is a smaller version of the neural network model and/or a compressed version of the neural network model.

In some aspects, the process 700 can include generating clusters of scene features in an output of the neural network element; training the first compute path using one or more clusters of the clusters of scene features; and training the second compute path using one or more different clusters of the clusters of scene features. In some examples, the first compute path can be selected over the second compute path when the output of the neural network element to be processed includes scene features matching or having a threshold similarity to the scene features in the one or more clusters of scene features used to train the first compute path, and the second compute path can be selected over the first compute path when the output of the neural network element to be processed includes scene features matching or having a threshold similarity to the scene features in the one or more different clusters of scene features used to train the second compute path.

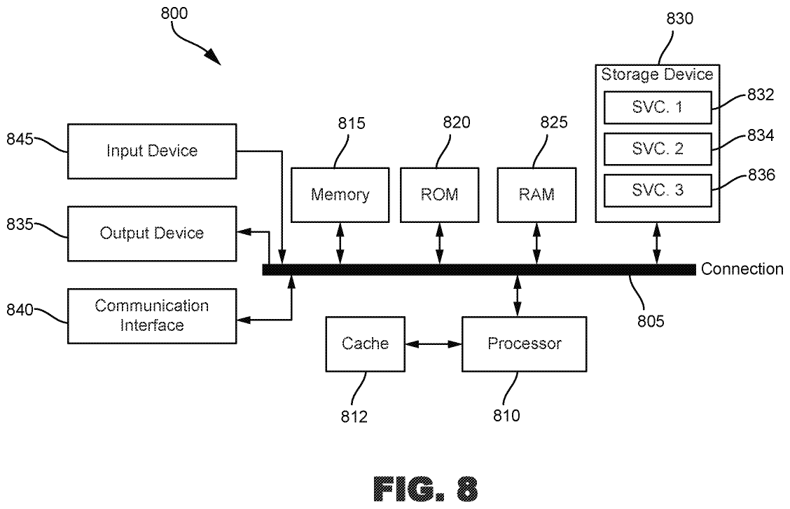

FIG. 8 illustrates an example processor-based system with which some aspects of the subject technology can be implemented. For example, processor-based system 800 can be any computing device making up local computing device 110, remote computing system 190, a passenger device executing the ridesharing application 170, or any component thereof in which the components of the system are in communication with each other using connection 805. Connection 805 can be a physical connection via a bus, or a direct connection into processor 810, such as in a chipset architecture. Connection 805 can also be a virtual connection, networked connection, or logical connection.

In some examples, computing system 800 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 800 includes at least one processing unit (CPU or processor) 810 and connection 805 that couples various system components including system memory 815, such as read-only memory (ROM) 820 and random-access memory (RAM) 825 to processor 810. Computing system 800 can include a cache of high-speed memory 812 connected directly with, in close proximity to, and/or integrated as part of processor 810.

Processor 810 can include any general-purpose processor and a hardware service or software service, such as services 832, 834, and 836 stored in storage device 830, configured to control processor 810 as well as a special-purpose processor where software instructions are incorporated into the actual processor design. Processor 810 may essentially be a completely self-contained computing system, containing multiple cores or processors, a bus, memory controller, cache, etc. A multi-core processor may be symmetric or asymmetric.

To enable user interaction, computing system 800 can include an input device 845, which can represent any number of input mechanisms, such as a microphone for speech, a touch-sensitive screen for gesture or graphical input, keyboard, mouse, motion input, speech, etc. Computing system 800 can also include output device 835, which can be one or more of a number of output mechanisms known to those of skill in the art. In some instances, multimodal systems can enable a user to provide multiple types of input/output to communicate with computing system 800. Computing system 800 can include communications interface 840, which can generally govern and manage the user input and system output. The communication interface may perform or facilitate receipt and/or transmission wired or wireless communications via wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/9G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

Communications interface 840 may also include one or more Global Navigation Satellite System (GNSS) receivers or transceivers that are used to determine a location of the computing system 800 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 830 can be a non-volatile and/or non-transitory computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L9/L #), resistive random-access memory (RRAM/ReRAM), phase change memory (PCM), spin transfer torque RAM (STT-RAM), another memory chip or cartridge, and/or a combination thereof.

Storage device 830 can include software services, servers, services, etc., that when the code that defines such software is executed by the processor 810, causes the system to perform a function. In some examples, a hardware service that performs a particular function can include the software component stored in a computer-readable medium in connection with the necessary hardware components, such as processor 810, connection 805, output device 835, etc., to carry out the function.

As understood by those of skill in the art, machine-learning techniques can vary depending on the desired implementation. For example, machine-learning schemes can utilize one or more of the following, alone or in combination: hidden Markov models; recurrent neural networks; convolutional neural networks (CNNs); deep learning; Bayesian symbolic methods; general adversarial networks (GANs); support vector machines; image registration methods; applicable rule-based system. Where regression algorithms are used, they may include including but are not limited to: a Stochastic Gradient Descent Regressor, and/or a Passive Aggressive Regressor, etc.

Machine learning classification models can also be based on clustering algorithms (e.g., a Mini-batch K-means clustering algorithm), a recommendation algorithm (e.g., a Miniwise Hashing algorithm, or Euclidean Locality-Sensitive Hashing (LSH) algorithm), and/or an anomaly detection algorithm, such as a Local outlier factor. Additionally, machine-learning models can employ a dimensionality reduction approach, such as, one or more of: a Mini-batch Dictionary Learning algorithm, an Incremental Principal Component Analysis (PCA) algorithm, a Latent Dirichlet Allocation algorithm, and/or a Mini-batch K-means algorithm, etc.

Aspects within the scope of the present disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special-purpose computer, or special-purpose processing device to perform a certain function or group of functions. By way of example, computer-executable instructions can be used to implement perception system functionality for determining when sensor cleaning operations are needed or should begin. Computer-executable instructions can also include program modules that are executed by computers in stand-alone or network environments. Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other examples of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Aspects of the disclosure may also be practiced in distributed computing environments where tasks are performed by local and remote processing devices that are linked (either by hardwired links, wireless links, or by a combination thereof) through a communications network. In a distributed computing environment, program modules can be located in both local and remote memory storage devices.

The various examples described above are provided by way of illustration only and should not be construed to limit the scope of the disclosure. For example, the principles herein apply equally to optimization as well as general improvements. Various modifications and changes may be made to the principles described herein without following the example aspects and applications illustrated and described herein, and without departing from the spirit and scope of the disclosure.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

Illustrative examples of the disclosure include:

Aspect 1. A system comprising: a memory; and one or more processors coupled to the memory, the one or more processors being configured to: determine a neural network element of a first compute path within a neural network model, the first compute path comprising a plurality of neural network elements including the neural network element, wherein the neural network element comprises at least one of a neural network layer and a neural network node; determine a second compute path comprising the neural network element and a different plurality of neural network elements, the second compute path having at least one of a smaller size than the first compute path, a lower latency than the first compute path, and a smaller compute cost than the second compute path; determine, based on one or more conditions, whether to process data from the neural network element through the first compute path or the second compute path; and process the data from the neural network element through one of the first compute path or the second compute path.

Aspect 2. The system of Aspect 1, wherein the first compute path is larger than the second compute path, and wherein the one or more conditions comprise a difference in an accuracy of a first output from the first compute path and a second output from the second compute path.

Aspect 3. The system of Aspect 2, wherein the one or more processors are configured to: determine the difference in the accuracy of the first output from the first compute path and the second output from the second compute path; and based on a determination that the difference in the accuracy is above a threshold, select to process the data from the neural network element via the first compute path.

Aspect 4. The system of claim 2, wherein the one or more processors are configured to: determine the difference in the accuracy of the first output from the first compute path and the second output from the second compute path; and based on a determination that the difference in the accuracy is below a threshold, select to process the data from the neural network element via the second compute path.

Aspect 5. The system of any of Aspects 1 to 4, wherein determining the second compute path comprises: copying the first compute path to yield a duplicated compute path; and downsizing the duplicated compute path to yield the second compute path.

Aspect 6. The system of Aspect 5, wherein downsizing the duplicated compute path comprises at least one of quantizing the duplicated compute path, pruning one or more portions of the duplicated compute path, and reducing a size of one or more neural network layers of the duplicated compute path.

Aspect 7. The system of any of Aspects 1 to 6, wherein first compute path comprises a first portion of the neural network model and the second compute path comprises a second portion of the neural network model.

Aspect 8. The system of any of Aspects 1 to 7, wherein first compute path comprises at least one of a branch of the neural network model and at least a portion of the neural network model, and wherein the second compute path comprises a different branch of the neural network model or an additional neural network model, and wherein the additional neural network model comprises at least one of a smaller version of the neural network model and a compressed version of the neural network model.

Aspect 9. The system of any of Aspects 1 to 8, wherein the one or more processors are configured to: generate clusters of scene features in an output of the neural network element; train the first compute path using one or more clusters of the clusters of scene features; and train the second compute path using one or more different clusters of the clusters of scene features.

Aspect 10. The system of any of Aspects 1 to 9, wherein the one or more conditions comprise a desired balance between at least two of a processing latency, a compute cost, a safety metric, or an output accuracy, and wherein the first compute path and the second compute path are associated with different processing latencies, different compute costs, different safety metrics, or different output accuracies.

Aspect 11. A method comprising: determining a neural network element of a first compute path within a neural network model, the first compute path comprising a plurality of neural network elements including the neural network element, wherein the neural network element comprises at least one of a neural network layer and a neural network node; determining a second compute path comprising the neural network element and a different plurality of neural network elements, the second compute path having at least one of a smaller size than the first compute path, a lower latency than the first compute path, and a smaller compute cost than the second compute path; determining, based on one or more conditions, whether to process data from the neural network element through the first compute path or the second compute path; and processing the data from the neural network element through one of the first compute path or the second compute path.

Aspect 12. The method of Aspect 11, wherein the first compute path is larger than the second compute path, and wherein the one or more conditions comprise a difference in an accuracy of a first output from the first compute path and a second output from the second compute path.

Aspect 13. The system of Aspect 12, further comprising: determining the difference in the accuracy of the first output from the first compute path and the second output from the second compute path; and based on a determination that the difference in the accuracy is above a threshold, selecting to process the data from the neural network element via the first compute path.

Aspect 14. The system of Aspect 12, further comprising: determining the difference in the accuracy of the first output from the first compute path and the second output from the second compute path; and based on a determination that the difference in the accuracy is below a threshold, selecting to process the data from the neural network element via the second compute path.

Aspect 15. The method of any of Aspects 11 to 14, wherein determining the second compute path comprises: copying the first compute path to yield a duplicated compute path; and downsizing the duplicated compute path to yield the second compute path.

Aspect 16. The system of Aspect 15, wherein downsizing the duplicated compute path comprises at least one of quantizing the duplicated compute path, pruning one or more portions of the duplicated compute path, and reducing a size of one or more neural network layers of the duplicated compute path.

Aspect 17. The method of any of Aspects 11 to 16, wherein first compute path comprises a first portion of the neural network model or a first branch of the neural network model, and wherein the second compute path comprises a second portion of the neural network model, a second branch of the neural network model, or an additional neural network model.

Aspect 18. The method of Aspect 18, wherein the additional neural network model comprises at least one of a smaller version of the neural network model and a compressed version of the neural network model.

Aspect 19. The method of any of Aspects 11 to 18, further comprising: generating clusters of scene features in an output of the neural network element; training the first compute path using one or more clusters of the clusters of scene features; and training the second compute path using one or more different clusters of the clusters of scene features.

Aspect 20. The method of any of Aspects 11 to 19, wherein the one or more conditions comprise a desired balance between at least two of a processing latency, a compute cost, a safety metric, or an output accuracy.

Aspect 21. The method of any of Aspects 11 to 20, wherein the first compute path and the second compute path are associated with different processing latencies, different compute costs, different safety metrics, or different output accuracies.

Aspect 22. A non-transitory computer-readable medium having stored thereon instructions which, when executed by one or more processors, cause the one or more processors to perform a method according to any of Aspects 11 to 21.

Aspect 23. A system comprising means for performing a method according to any of Aspects 11 to 21.

Aspect 24. A computer-program product comprising instructions which, when executed by one or more processors, cause the one or more processors to perform a method according to any of Aspects 11 to 21.

Aspect 25. An autonomous vehicle comprising a computer system, the computer system comprising memory and one or more processors coupled to the memory, wherein the one or more processors are configured to perform a method according to any of Aspects 11 to 21.

What is claimed is:

1. A system comprising:
a memory; and
one or more processors coupled to the memory, the one or more processors being configured to:
determine a neural network element of a first compute path within a neural network model, the first compute path comprising a plurality of neural network elements including the neural network element, wherein the neural network element comprises at least one of a neural network layer and a neural network node;
determine a second compute path comprising the neural network element and a different plurality of neural network elements, the second compute path having at least one of a smaller size than the first compute path, a lower latency than the first compute path, and a smaller compute cost than the second compute path;
determine, based on one or more conditions, whether to process data from the neural network element through the first compute path or the second compute path; and
process the data from the neural network element through one of the first compute path or the second compute path.

2. The system of claim 1, wherein the first compute path is larger than the second compute path, and wherein the one or more conditions comprise a difference in an accuracy of a first output from the first compute path and a second output from the second compute path.

3. The system of claim 2, wherein the one or more processors are configured to:
determine the difference in the accuracy of the first output from the first compute path and the second output from the second compute path; and
based on a determination that the difference in the accuracy is above a threshold, select to process the data from the neural network element via the first compute path.

4. The system of claim 2, wherein the one or more processors are configured to:
determine the difference in the accuracy of the first output from the first compute path and the second output from the second compute path; and
based on a determination that the difference in the accuracy is below a threshold, select to process the data from the neural network element via the second compute path.

5. The system of claim 1, wherein determining the second compute path comprises:
copying the first compute path to yield a duplicated compute path; and
downsizing the duplicated compute path to yield the second compute path.

6. The system of claim 5, wherein downsizing the duplicated compute path comprises at least one of quantizing the duplicated compute path, pruning one or more portions of the duplicated compute path, and reducing a size of one or more neural network layers of the duplicated compute path.

7. The system of claim 1, wherein first compute path comprises a first portion of the neural network model and the second compute path comprises a second portion of the neural network model.

8. The system of claim 1, wherein first compute path comprises at least one of a branch of the neural network model and at least a portion of the neural network model, and wherein the second compute path comprises a different branch of the neural network model or an additional neural network model, and wherein the additional neural network model comprises at least one of a smaller version of the neural network model and a compressed version of the neural network model.

9. The system of claim 1, wherein the one or more processors are configured to:
generate clusters of scene features in an output of the neural network element;
train the first compute path using one or more clusters of the clusters of scene features; and
train the second compute path using one or more different clusters of the clusters of scene features.

10. The system of claim 1, wherein the one or more conditions comprise a desired balance between at least two of a processing latency, a compute cost, a safety metric, or an output accuracy, and wherein the first compute path and the second compute path are associated with different processing latencies, different compute costs, different safety metrics, or different output accuracies.

11. A method comprising:
determining a neural network element of a first compute path within a neural network model, the first compute path comprising a plurality of neural network elements including the neural network element, wherein the neural network element comprises at least one of a neural network layer and a neural network node;
determining a second compute path comprising the neural network element and a different plurality of neural network elements, the second compute path having at least one of a smaller size than the first compute path, a lower latency than the first compute path, and a smaller compute cost than the second compute path;
determining, based on one or more conditions, whether to process data from the neural network element through the first compute path or the second compute path; and
processing the data from the neural network element through one of the first compute path or the second compute path.

12. The method of claim 11, wherein the first compute path is larger than the second compute path, and wherein the one or more conditions comprise a difference in an accuracy of a first output from the first compute path and a second output from the second compute path.

13. The system of claim 12, further comprising:
determining the difference in the accuracy of the first output from the first compute path and the second output from the second compute path; and
based on a determination that the difference in the accuracy is above a threshold, selecting to process the data from the neural network element via the first compute path.

14. The system of claim 12, further comprising:
determining the difference in the accuracy of the first output from the first compute path and the second output from the second compute path; and
based on a determination that the difference in the accuracy is below a threshold, selecting to process the data from the neural network element via the second compute path.

15. The method of claim 11, wherein determining the second compute path comprises:
copying the first compute path to yield a duplicated compute path; and
downsizing the duplicated compute path to yield the second compute path.

16. The system of claim 15, wherein downsizing the duplicated compute path comprises at least one of quantizing the duplicated compute path, pruning one or more portions of the duplicated compute path, and reducing a size of one or more neural network layers of the duplicated compute path.

17. The method of claim 11, wherein first compute path comprises a first portion of the neural network model or a first branch of the neural network model, and wherein the second compute path comprises a second portion of the neural network model, a second branch of the neural network model, or an additional neural network model, wherein the additional neural network model comprises at least one of a smaller version of the neural network model and a compressed version of the neural network model.

18. The method of claim 11, further comprising:
generating clusters of scene features in an output of the neural network element;
training the first compute path using one or more clusters of the clusters of scene features; and
training the second compute path using one or more different clusters of the clusters of scene features.

19. The method of claim 11, wherein the one or more conditions comprise a desired balance between at least two of a processing latency, a compute cost, a safety metric, or an output accuracy, and wherein the first compute path and the second compute path are associated with different processing latencies, different compute costs, different safety metrics, or different output accuracies.

20. A non-transitory computer-readable medium having stored thereon instructions which, when executed by one or more processors, cause the one or more processors to:
determine a neural network element of a first compute path within a neural network model, the first compute path comprising a plurality of neural network elements including the neural network element, wherein the neural network element comprises at least one of a neural network layer and a neural network node;
determine a second compute path comprising the neural network element and a different plurality of neural network elements, the second compute path having at least one of a smaller size than the first compute path, a lower latency than the first compute path, and a smaller compute cost than the second compute path;
determine, based on one or more conditions, whether to process data from the neural network element through the first compute path or the second compute path; and
process the data from the neural network element through one of the first compute path or the second compute path.
